(19) United States
(12) Patent Application Publication
(10) Pub. No.: US 2017/0105014 A1
(43) Pub. Date: Apr. 13, 2017

(54) LUMA-DRIVEN CHROMA SCALING FOR HIGH DYNAMIC RANGE AND WIDE COLOR GAMUT CONTENTS

(71) Applicant: QUALCOMM Incorporated, San Diego, CA (US)

(72) Inventors: Sungwon LEE, San Diego, CA (US); Adarsh Krishnan RAMASUBRAMONIAN, San Diego, CA (US); Dmytro RUSANOVSKYY, San Diego, CA (US); Joel SOLE ROJALS, San Diego, CA (US); Done BUGDAYCI SANSLI, San Diego, CA (US); Marta KARCZEWICZ, San Diego, CA (US)

(21) Appl. No.: 15/287,494

(22) Filed: Oct. 6, 2016

Related U.S. Application Data
(60) Provisional application No. 62/239,257, filed on Oct. 8, 2015.

(51) Int. Cl. H04N 19/30

(52) U.S. Cl. CPC H04N 19/30; H04N 19/186

(57) ABSTRACT

The present disclosure provides various aspects related to luma-driven chroma scaling for high dynamic range and wide color gamut contents. For example, a method of video data decoding may include obtaining video data, where the video data includes a scaled chroma component and a luma component, and where the scaled chroma component is scaled based on a chroma scaling factor that is a non-linear function of the luma component. The method may also include obtaining the chroma scaling factor for the scaled chroma component and generating a chroma component from the scaled chroma component based on the chroma scaling factor. In addition, the method may include outputting the chroma component, which may then be used for further processing.

### PRIORITY

The present application for patent claims priority to Provisional Application No. 62/239,257 entitled “LUMA-DRIVEN CHROMA SCALING FOR HIGH DYNAMIC RANGE AND WIDE COLOR GAMUT CONTENTS” filed on Oct. 8, 2015, which is assigned to the assignee hereof and hereby expressly incorporated by reference herein for all purposes.

### BACKGROUND

This present disclosure is related to various techniques used in video processing applications, including video coding and compression. More specifically, this disclosure relates to compression of high dynamic range (HDR) and wide color gamut (WCG) video data.

Next generation video applications are expected to operate with video data that represents scenery captured in HDR and WCG conditions. There are different parameters used to represent dynamic range and color gamut, which are two independent attributes of the content in the video data. The specification of dynamic range and color gamut for purposes of digital television and multimedia services generally is provided by several international standards. For example the International Telecommunication Union Radiocommunication Sector (ITU-R) Rec. 709 defines parameters for high-definition television (HDTV) such as standard dynamic range and standard color gamut, while ITU-R Rec.2020 specifies ultra-high-definition television (UHDTV) parameters such as high dynamic range and wide color gamut. There are also other standard developing organizations (SDOs) that have developed documentation specifying these attributes (e.g., dynamic range, color gamut) in other systems. For example, the Digital Cinema Initiatives P3 (DCI-P3) color space (e.g., color gamut) is defined by the Society of Motion Picture and Television Engineers (SMPTE) in SMPTE 231-2, while some parameters for high dynamic range, such as electro-optical transfer function (EOTF) are defined in SMPTE 2084.

The processing of HDR and WCG video data may be performed in connection with various video coding standards, including but not limited to, for example, ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions, and ITU-T H.265 (also known as ISO/IEC MPEG-4 HEVC), including its scalable and multiview extensions SHVC and MV-HEVC, respectively.

In view of the growing use of video applications in HDR and WCG conditions, it is desirable to enable more efficient techniques for compression of HDR and WCG video data.

### SUMMARY

Aspects of the present disclosure provide techniques for coding of video signals with HDR and WCG representations. More specifically, aspects of the present disclosure specify signaling and operations applied to video data in certain color spaces to enable more efficient compression of HDR and WCG video data. The proposed techniques described herein improve the compression efficiency of hybrid-based video coding systems used for coding HDR and WCG video data.

The present disclosure provides for a method of video data decoding in high dynamic range and wide color gamut operations that includes obtaining video data, where the video data has a scaled chroma component and a luma component, and where the scaled chroma component is scaled based on a chroma scaling factor that is a non-linear function of the luma component. The method also includes obtaining the chroma scaling factor for the scaled chroma component and generating a chroma component from the scaled chroma component based on the chroma scaling factor. The chroma component is then output for further processing and/or storage.

The present disclosure also provides for a device for video data decoding in high dynamic range and wide color gamut operations that includes a memory configured to store video data and a processor. The processor is configured to obtain the video data, where the video data including a scaled chroma component and a luma component, and where the scaled chroma component is scaled based on a chroma scaling factor that is a non-linear function of the luma component. The processor is also configured to obtain the chroma scaling factor for the scaled chroma component and generate a chroma component from the scaled chroma component based on the chroma scaling factor. The processor is also configured to output the chroma component for further processing and/or storage.

The present disclosure also provides for a computer-readable medium storing code for video data decoding in high dynamic range and wide color gamut operations, the code is executable by a processor to perform a method including obtaining video data, where the video data has a scaled chroma component and a luma component, and where the scaled chroma component is scaled based on a chroma scaling factor that is a non-linear function of the luma component. The method also includes obtaining the chroma scaling factor for the scaled chroma component and generating a chroma component from the scaled chroma component based on the chroma scaling factor. The chroma component is then output for further processing and/or storage.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1A is a block diagram illustrating an example of an encoding device and a decoding device, in accordance with various aspects of the disclosure.

FIG. 1B is a diagram illustrating an example of a network including a wireless communication device, in accordance with various aspects of the disclosure.

FIG. 2 is a diagram illustrating the standard dynamic range (SDR) of HDTV, the expected high dynamic range (HDR) of UHDTV, and the dynamic range of the human visual system (HVS), in accordance with various aspects of the disclosure.

FIG. 3 is diagram illustrating an example of color gamuts for SDR and for UHDTV, in accordance with various aspects of the disclosure.

FIG. 4A is a block diagram that illustrates an example of HDR/WCG representation conversion, in accordance with various aspects of the disclosure.

FIG. 4B is a block diagram that illustrates an example of inverse HDR/WCG representation conversion, in accordance with various aspects of the disclosure.

FIG. 5 is a block diagram that illustrates an example of encoding/decoding chains using red-green-blue (RGB) linear light, in accordance with various aspects of the disclosure.

FIG. 6 is a diagram that illustrates an example of electro-optical transfer functions (EOTFs), in accordance with various aspects of the disclosure.

FIG. 7 is a block diagram that illustrates an example of a non-constant luminance (NCL) video data processing, in accordance with various aspects of the disclosure.

FIG. 8 is a block diagram illustrates an example of a constant luminance (CL) video data processing, in accordance with various aspects of the disclosure.

FIG. 9 is a diagram that illustrates an example of a color remapping information (CRI) supplemental enhancement information (SEI) message, in accordance with various aspects of the disclosure.

FIGS. 10A and 10B illustrate an example of visual quality improvement with an anchor image on the left and an image using blind chroma scaling on the right.

FIGS. 11A and 11B illustrate another example of visual quality improvement with an anchor image on the left and an image using blind chroma scaling on the right.

FIGS. 12A-12C illustrate examples of chroma artifacts from chroma scaling with hard-thresholding.

FIG. 13 is a block diagram that illustrates an example of simplified encoding and decoding chains with luma-driven chroma scaling (LCS), in accordance with various aspects of the disclosure.

FIG. 14 is a diagram that illustrates an example of an LCS function, in accordance with various aspects of the disclosure.

FIGS. 15A and 15B are diagrams that illustrate different examples of Cb and Cr visualization, in accordance with various aspects of this disclosure.

FIGS. 16A-16D are diagrams that illustrate different examples of LCS functions for Cb and Cr in different gamuts, in accordance with various aspects of the disclosure.

FIG. 17 is a block diagram illustrating an example of a processing system configured to perform various of luma-driven chroma scaling, in accordance with various aspects of the disclosure.

FIG. 18 is a flow chart illustrating an example method for decoding video data in HDR and WCG operations, in accordance with various aspects of the disclosure.

FIG. 19 is a block diagram illustrating an example video encoding device, in accordance with various aspects of the disclosure.

FIG. 20 is a block diagram illustrating an example video decoding device, in accordance with various aspects of the disclosure.

### DETAILED DESCRIPTION

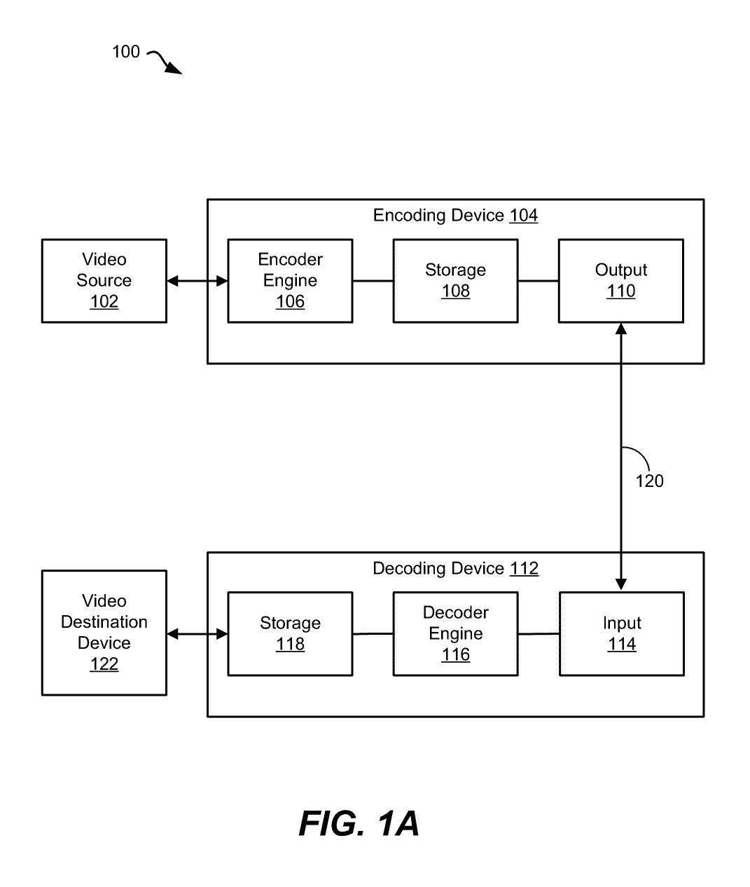

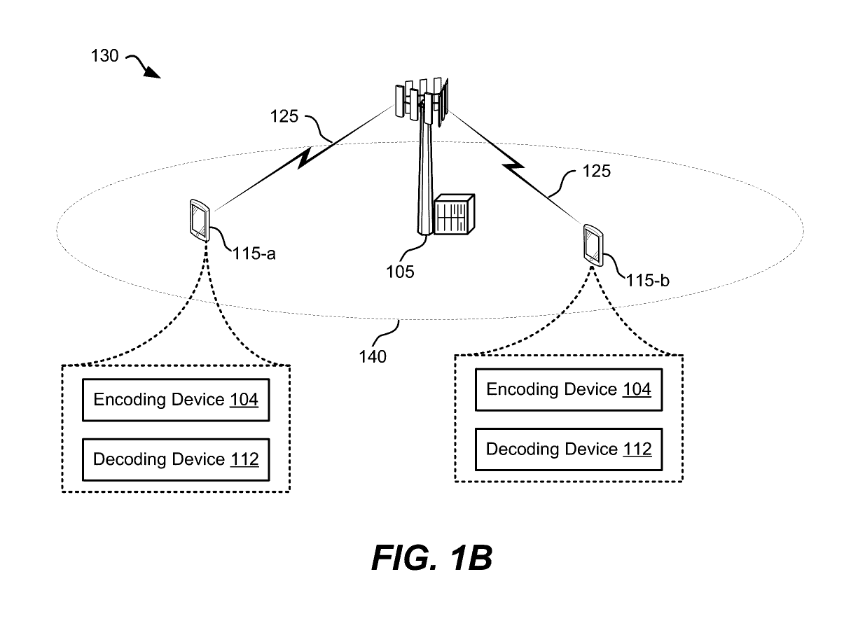

Certain aspects of this disclosure are provided below. For example, various aspects related to luma-driven chroma scaling for high dynamic range (HDR) and wide color gamut (WCG) contents in video data are described. Some of these aspects may be applied independently and some of them may be applied in combination as would be apparent to those of skill in the art. In the following description, for the purposes of explanation, specific details are set forth in order to provide a thorough understanding of the disclosure. However, it will be apparent that various aspects of the disclosure may be practiced without these specific details. The figures (e.g., FIGS. 1A-20) and description are not intended to be restrictive.

Therefore, the ensuing description provides examples of different aspects, and is not intended to limit the scope, applicability, or configuration of the disclosure. Rather, the ensuing description of the examples will provide those skilled in the art with an enabling description for implementing different aspects of the disclosure. It should be understood that various changes may be made in the function and arrangement of elements without departing from the scope of the disclosure as set forth in the appended claims.

Specific details are given in the following description to provide a thorough understanding of the various aspects related to luma-driven chroma scaling for HDR and WCG contents in video data. However, it will be understood by one of ordinary skill in the art that the various aspects may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the various aspects being described.

As described above, the present disclosure provides techniques for coding of video signals with HDR and WCG representations. More specifically, aspects of the present disclosure specify signaling and operations applied to video data in certain color spaces to enable more efficient compression of HDR and WCG video data. The proposed techniques described herein address some of the issues arising from handling HDR and WCG video data by improving the compression efficiency of hybrid based video coding systems used for coding HDR and WCG video data.

The proposed techniques may be implemented in different types of devices, including wireless communication devices that are used to send and/or receive information representative of video data such as HDR and WCG video data. The wireless communication devices may be, for example, a cellular telephone or similar device, and the information representative of the video data may be transmitted and/or received by the wireless communication device and may be modulated according to a cellular communication standard.

FIG. 1A is a block diagram illustrating an example of a system 100 including an encoding device 104 and a decoding device 112. The encoding device 104 may be part of a source device, and the decoding device 112 may be part of a receiving device. It is to be understood, however, that a source device may include both an encoding device 104 and a decoding device 112; similarly for a receiving device (see e.g., FIG. 1B). The source device and/or the receiving device may include or may be part of an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, or any other suitable electronic device. In some examples, the source device and the receiving device may include one or more wireless transceivers for wireless communications. The coding techniques described herein are applicable to video coding in various multimedia applications, including streaming video transmissions (e.g., over the internet), television broadcasts or transmissions, encoding of digital video for storage on a data storage medium, decoding of digital video stored on a data storage medium, or other applications. In some examples, system 100 can support one-way or two-way video transmission to support applications such as video conferencing, video streaming, video playback, video broadcasting, gaming, virtual reality, and/or video telephony. Moreover, a source device as described above may include a video source, a video encoder, and a output interface. A destination device as described above may include an input interface, a video decoder, and a display device. A display device as described herein may display video data to a user, and may comprise any of a variety of display devices such as a cathode ray tube (CRT), a liquid crystal display (LCD), a plasma display, an organic light emitting diode (OLED) display, or another type of display device.

Aspects of the use of luma-driven chroma scaling (LCS) as described in more detail below can be implemented in the encoding device 104 and in the decoding device 112. For example, LCS may be applied as a pre-processing operation to the encoding operation performed by the encoding device 104. Similarly, an inverse LCS may be applied as a post-processing operation to the decoding operation performed by the decoding device 112.

The encoding device 104 (or encoder) can be used to encode video data using a video coding standard or protocol to generate an encoded video bitstream. Video coding standards may include, but need not be limited to, ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. Another coding standard, High-Efficiency Video Coding (HEVC), has been finalized by the Joint Collaboration Team on Video Coding (JCT-VC) of ITU-T Video Coding Experts Group (VCEG) and ISO/IEC Motion Picture Experts Group (MPEG). Various extensions to HEVC deal with multi-layer video coding and are also being developed by the JCT-VC, including the multiview extension to HEVC, called MV-HEVC, and the scalable extension to HEVC, called SHVC, or any other suitable coding protocol. Further, investigation of new coding tools for screen-content material such as text and graphics with motion has been conducted, and technologies that improve the coding efficiency for screen content have been proposed. A H.265/HEVC screen content coding (SCC) extension is being developed to cover these new coding tools.

Various aspects of the disclosure describe examples using the HEVC standard, or extensions thereof. However, the techniques and systems described herein may also be applicable to other coding standards, such as AVC, MPEG, extensions thereof, or other suitable coding standards. Accordingly, while the techniques and systems described herein may be described with reference to a particular video coding standard, one of ordinary skill in the art will appreciate that the description should not be so limited and need not be interpreted to apply only to that particular standard.

A video source 102 may provide the video data to the encoding device 104. The video source 102 may be part of the source device, or may be part of a device other than the source device. The video source 102 may include a video capture device (e.g., a video camera, a camera phone, a video phone, or the like), a video archive containing stored video, a video server or content provider providing video data, a video feed interface receiving video from a video server or content provider, a computer graphics system for generating computer graphics video data, a combination of such sources, or any other suitable video source.

In some aspects, the video data provided by the video source 102 may be captured under high dynamic range (HDR) and/or wide color gamut (WCG) conditions. In other aspects, the video data from the video source 102 may be processed or configured, by the video source 102 and/or by some other component, in accordance with HDR and/or WCG specifications.

The video data from the video source 102 may include one or more input pictures or frames. A picture or frame is a still image that is part of a sequence of images that form a video. The encoder engine 106 (or encoder) of the encoding device 104 encodes the video data to generate an encoded video bitstream. In some examples, an encoded video bitstream (or “bitstream”) is a series of one or more coded video sequences. A coded video sequence (CVS) includes a series of access units (AUs) starting with an AU that has a random access point picture in the base layer and with certain properties up to and not including a next AU that has a random access point picture in the base layer and with certain properties. For example, the certain properties of a random access point picture that starts a CVS may include a RASL flag (e.g., NoRaslOutputFlag) equal to 1. Otherwise, a random access point picture (with RASL flag equal to 0) does not start a CVS. An AU includes one or more coded pictures and control information corresponding to the coded pictures that share the same output time. An HEVC bitstream, for example, may include one or more CVSs including data units called network abstraction layer (NAL) units. Two classes of NAL units exist in the HEVC standard, including video coding layer (VCL) NAL units and non-VCL NAL units. A VCL NAL unit includes one slice or slice segment (described below) of coded picture data, and a non-VCL NAL unit includes control information that relates to one or more coded pictures. An HEVC AU includes VCL NAL units containing coded picture data and non-VCL NAL units (if any) corresponding to the coded picture data.

NAL units may contain a sequence of bits forming a coded representation of the video data (e.g., an encoded video bitstream, a CVS of a bitstream, or the like), such as coded representations of pictures in a video. The encoder engine 106 generates coded representations of pictures by partitioning each picture into multiple slices. A slice is independent of other slices so that information in the slice is coded without dependency on data from other slices within the same picture. A slice includes one or more slice segments including an independent slice segment and, if present, one or more dependent slice segments that depend on previous slice segments. The slices are then partitioned into coding tree blocks (CTBs) of luma samples and chroma samples. Luma generally refers to brightness of a sample and is considered achromatic. Chroma, on the other hand, carries color information. A CTB of luma samples and one or more CTBs of chroma samples, along with syntax for the samples, are referred to as a coding tree unit (CTU). A CTU is the basic processing unit for HEVC encoding. A CTU can be split into multiple coding units (CUs) of varying sizes. A CU contains luma and chroma sample arrays that are referred to as coding blocks (CBs).

The luma and chroma CBs can be further split into prediction blocks (PBs). A PB is a block of samples of the luma or a chroma component that uses the same motion parameters for inter-prediction. The luma PB and one or more chroma PBs, together with associated syntax, form a prediction unit (PU). A set of motion parameters is signaled in the bitstream for each PU and is used for inter-prediction of the luma PB and the one or more chroma PBs. A CB can also be partitioned into one or more transform blocks (TBs). A TB represents a square block of samples of a color component on which the same two-dimensional transform is applied for coding a prediction residual signal. A transform unit (TU) represents the TBs of luma and chroma samples, and corresponding syntax elements.

A size of a CU corresponds to a size of the coding node and is square in shape. For example, a size of a CU may be 8×8 samples, 16×16 samples, 32×32 samples, 64×64 samples, or any other appropriate size up to the size of the corresponding CTU. The phrase “N×N” is used herein to refer to pixel dimensions of a video block in terms of vertical and horizontal dimensions (e.g., 8 pixels×8 pixels). The pixels in a block may be arranged in rows and columns. In some examples, blocks may not have the same number of pixels in a horizontal direction as in a vertical direction. Syntax data associated with a CU may describe, for example, partitioning of the CU into one or more PUs. Partitioning modes may differ between whether the CU is intra-prediction mode encoded or inter-prediction mode encoded. PUs may be partitioned to be non-square in shape. Syntax data associated with a CU may also describe, for example, partitioning of the CU into one or more TUs according to a CTU. A TU can be square or non-square in shape.

According to the HEVC standard, transformations may be performed using transform units (TUs). TUs may vary for different CUs. The TUs may be sized based on the size of PUs within a given CU. The TUs may be the same size or smaller than the PUs. In some examples, residual samples corresponding to a CU may be subdivided into smaller units using a quadtree structure known as residual quad tree (RQT). Leaf nodes of the RQT may correspond to TUs. Pixel difference values associated with the TUs may be transformed to produce transform coefficients. The transform coefficients may then be quantized by the encoder engine 106.

Once the pictures of the video data are partitioned into CUs, the encoder engine 106 predicts each PU using a prediction mode. The prediction is then subtracted from the original video data to get residuals (described below). For each CU, a prediction mode may be signaled inside the bitstream using syntax data. A prediction mode may include intra-prediction (or intra-picture prediction) or inter-prediction (or inter-picture prediction). Using intra-prediction, each PU is predicted from neighboring image data in the same picture using, for example, DC prediction to find an average value for the PU, planar prediction to fit a planar surface to the PU, direction prediction to extrapolate from neighboring data, or any other suitable types of prediction. Using inter-prediction, each PU is predicted using motion compensation prediction from image data in one or more reference pictures (before or after the current picture in output order). The decision whether to code a picture area using inter-picture or intra-picture prediction may be made, for example, at the CU level.

In some examples, inter-prediction using uni-prediction may be performed, in which case each prediction block can use one motion compensated prediction signal, and P prediction units are generated. In some examples, inter-prediction using bi-prediction may be performed, in which case each prediction block uses two motion compensated prediction signals, and B prediction units are generated.

A PU may include data related to the prediction process. For example, when the PU is encoded using intra-prediction, the PU may include data describing an intra-prediction mode for the PU. As another example, when the PU is encoded using inter-prediction, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

The encoder engine 106 in the encoding device 104 may then perform transformation and quantization (examples of which are provided below at least in connection with encoding chains using LCS). For example, following prediction, the encoder engine 106 may calculate residual values corresponding to the PU. Residual values may comprise pixel difference values. Any residual data that may be remaining after prediction is performed is transformed using a block transform, which may be based on discrete cosine transform, discrete sine transform, an integer transform, a wavelet transform, or other suitable transform function. In some cases, one or more block transforms (e.g., sizes 32×32, 16×16, 8×8, 4×4, or the like) may be applied to residual data in each CU. In some embodiments, a TU may be used for the transform and quantization processes implemented by the encoder engine 106. A given CU having one or more PUs may also include one or more TUs. As described in further detail below, the residual values may be transformed into transform coefficients using the block transforms, and then may be quantized and scanned using TUs to produce serialized transform coefficients for entropy coding.

In some embodiments following intra-predictive or inter-predictive coding using PUs of a CU, the encoder engine 106 may calculate residual data for the TUs of the CU. The PUs may comprise pixel data in the spatial domain (or pixel domain). The TUs may comprise coefficients in the transform domain following application of a block transform. As previously noted, the residual data may correspond to pixel difference values between pixels of the unencoded picture and prediction values corresponding to the PUs. The encoder engine 106 may form the TUs including the residual data for the CU, and may then transform the TUs to produce transform coefficients for the CU.

The encoder engine 106 may perform quantization of the transform coefficients. Quantization provides further compression by quantizing the transform coefficients to reduce the amount of data used to represent the coefficients. For example, quantization may reduce the bit depth associated with some or all of the coefficients. In one example, a coefficient with an n-bit value may be rounded down to an m-bit value during quantization, with n being greater than m.

Once quantization is performed, the coded bitstream includes quantized transform coefficients, prediction information (e.g., prediction modes, motion vectors, or the like), partitioning information, and any other suitable data, such as other syntax data. The different elements of the coded bitstream may then be entropy encoded by the encoder engine 106. In some examples, the encoder engine 106 may utilize a predefined scan order to scan the quantized transform coefficients to produce a serialized vector that can be entropy encoded. In some examples, encoder engine 106 may perform an adaptive scan. After scanning the quantized transform coefficients to form a one-dimensional vector, the encoder engine 106 may entropy encode the one-dimensional vector. For example, the encoder engine 106 may use context adaptive variable length coding, context adaptive binary arithmetic coding, syntax-based context-adaptive binary arithmetic coding, probability interval partitioning entropy coding, or another suitable entropy encoding technique.

As previously described, an HEVC bitstream includes a group of NAL units. A sequence of bits forming the coded video bitstream is present in VCL NAL units. Non-VCL NAL units may contain parameter sets with high-level information relating to the encoded video bitstream, in addition to other information. For example, a parameter set may include a video parameter set (VPS), a sequence parameter set (SPS), and a picture parameter set (PPS). The goal of the parameter sets is bit rate efficiency, error resiliency, and providing systems layer interfaces. Each slice references a single active PPS, SPS, and VPS to access information that the decoding device 112 may use for decoding the slice. An identifier (ID) may be coded for each parameter set, including a VPS ID, an SPS ID, and a PPS ID. An SPS includes an SPS ID and a VPS ID. A PPS includes a PPS ID and an SPS ID. Each slice header includes a PPS ID. Using the IDs, active parameter sets can be identified for a given slice.

A PPS includes information that applies to all slices in a given picture. Because of this, all slices in a picture refer to the same PPS. Slices in different pictures may also refer to the same PPS. An SPS includes information that applies to all pictures in a same coded video sequence (CVS) or bitstream. As previously described, a coded video sequence is a series of access units (AUs) that starts with a random access point picture (e.g., an instantaneous decode reference (IDR) picture or broken link access (BLA) picture, or other appropriate random access point picture) in the base layer and with certain properties (described above) up to and not including a next AU that has a random access point picture in the base layer and with certain properties (or the end of the bitstream). The information in an SPS may not change from picture to picture within a coded video sequence. Pictures in a coded video sequence may use the same SPS. The VPS includes information that applies to all layers within a coded video sequence or bitstream. The VPS includes a syntax structure with syntax elements that apply to entire coded video sequences. In some embodiments, the VPS, SPS, or PPS may be transmitted in-band with the encoded bitstream. In some embodiments, the VPS, SPS, or PPS may be transmitted out-of-band in a separate transmission than the NAL units containing coded video data.

The output 110 of the encoding device 104 may send the NAL units making up the encoded video data over the communications link 120 (e.g., communication links 125 in FIG. 1B) to the decoding device 112 of the receiving device. The input 114 of the decoding device 112 may receive the NAL units. The communications link 120 may include a signal transmitted using a wireless network, a wired network, or a combination of a wired and wireless network. A wireless network may include any wireless interface or combination of wireless interfaces and may include any suitable wireless network (e.g., the internet or other wide area network, a packet-based network, Wi-Fi, radio frequency (RF), UWB, WiFi-Direct, cellular, Long-Term Evolution (LTE), WiMax, or the like). An example of a wireless network is illustrated in FIG. 1B. A wired network may include any wired interface (e.g., fiber, ethernet, powerline ethernet, ethernet over coaxial cable, digital signal line (DSL), or the like). The wired and/or wireless networks may be implemented using various equipment, such as base stations, routers, access points, bridges, gateways, switches, or the like. The encoded video data may be modulated according to a communication standard, such as a wireless communication protocol, and transmitted to the receiving device.

In some examples, the encoding device 104 may store encoded video data in storage 108. The output 110 may retrieve the encoded video data from the encoder engine 106 or from the storage 108. The storage 108 may include any of a variety of distributed or locally accessed data storage media. For example, the storage 108 may include a hard drive, a storage disc, flash memory, volatile or non-volatile memory, or any other suitable digital storage media for storing encoded video data. Although shown as separate from the encoder engine 106, the storage 108, or at least part of the storage 108, may be implemented as part of the encoder engine 106.

The input 114 receives the encoded video data and may provide the video data to the decoder engine 116 (or decoder) or to the storage 118 for later use by the decoder engine 116. The decoder engine 116 may decode the encoded video data by entropy decoding (e.g., using an entropy decoder) and extracting the elements of the coded video sequence making up the encoded video data. The decoder engine 116 may then rescale and perform an inverse transform on the encoded video data. Residues are then passed to a prediction stage of the decoder engine 116. The decoder engine 116 may then predict a block of pixels (e.g., a PU). In some examples, the prediction is added to the output of the inverse transform. Examples of the operation of the decoder engine 116 at least in connection with decoding chains using LCS are provided below.

The decoding device 112 may output the decoded video to a video destination device 122, which may include a display or other output device for displaying the decoded video data to a consumer of the content. In some aspects, the video destination device 122 may be part of the receiving device that includes the decoding device 112. In some aspects, the video destination device 122 may be part of a separate device other than the receiving device.

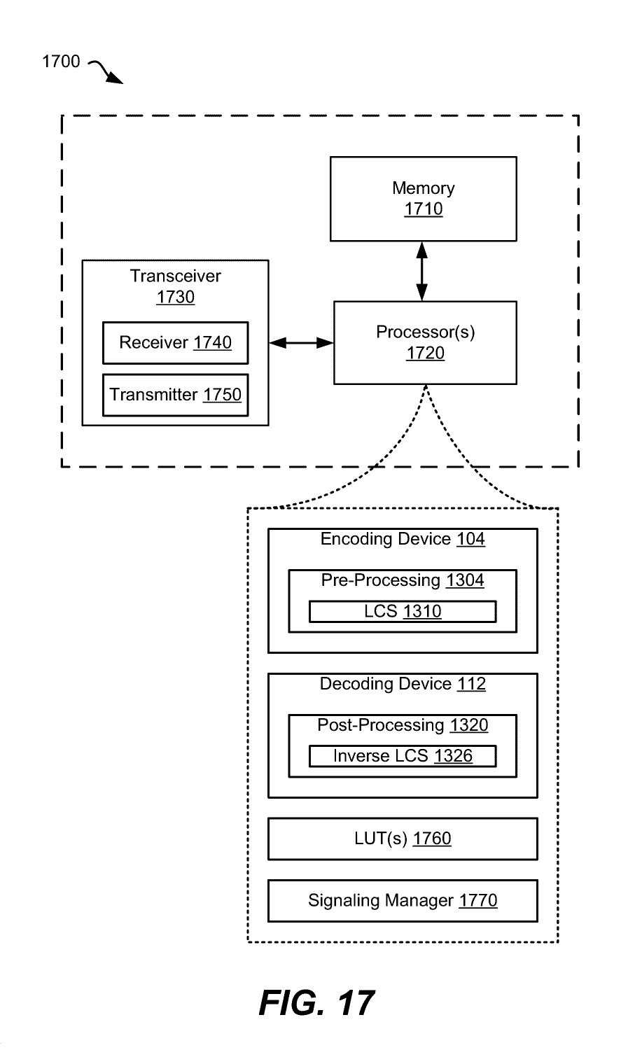

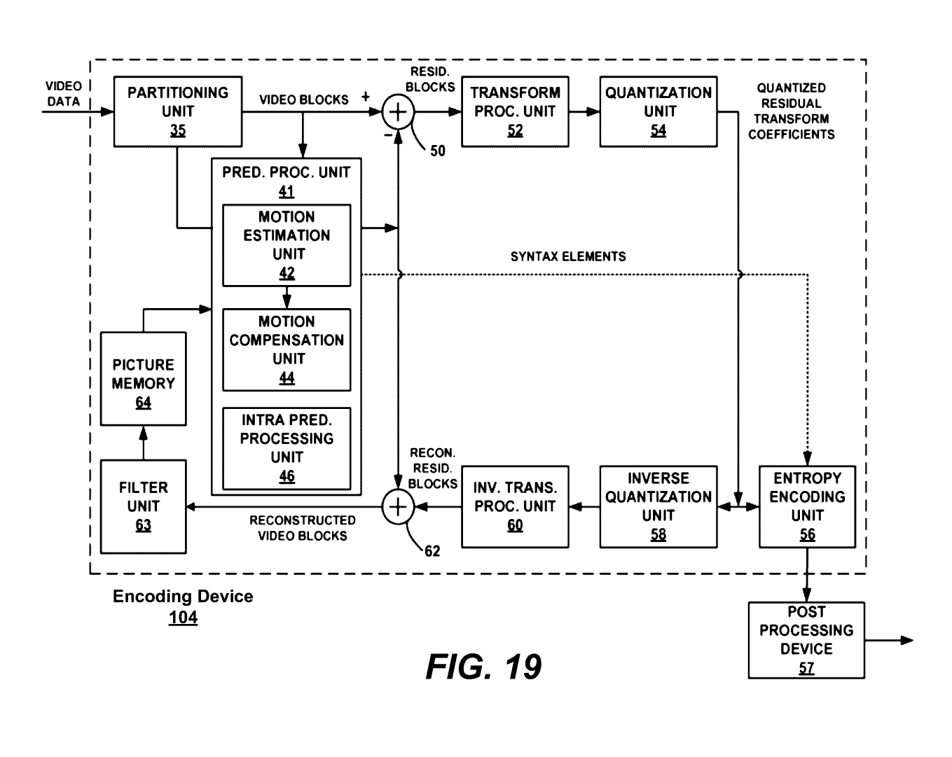

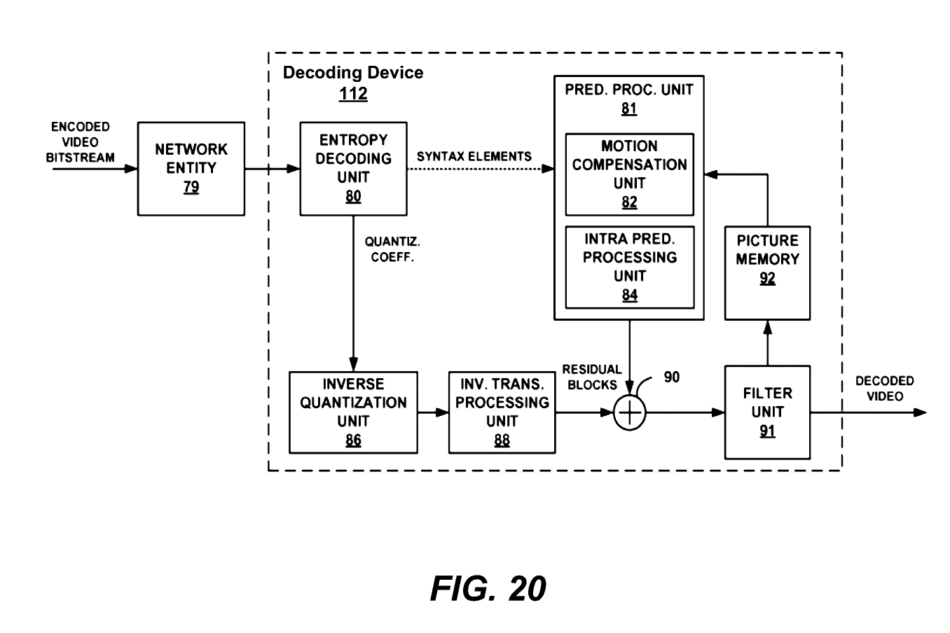

In some aspects, the encoding device 104 and/or the decoding device 112 may be integrated with an audio encoding device and audio decoding device, respectively. The encoding device 104 and/or the decoding device 112 may also include other hardware or software that is necessary to implement the coding techniques described above, such as one or more microprocessors, digital signal processors (DSPs), application specific integrated circuits (ASICs), field programmable gate arrays (FPGAs), discrete logic, software, hardware, firmware or any combinations thereof. The encoding device 104 and the decoding device 112 may be integrated as part of a combined encoder/decoder (codec) in a respective device. An example of specific details of the encoding device 104 is described below with reference to FIG. 19. An example of specific details of the decoding device 112 is described below with reference to FIG. 20. Additionally, aspects of the hardware implementation of the encoding device 104 and/or the decoding device 112 in a processing device, such as a wireless communication device, are described in more detail below with respect to FIG. 17. FIG. 17 also provides additional details as to the application of LCS in the encoding device 104 and the application of inverse LCS in the decoding device 112.

Extensions to the HEVC standard include the Multiview Video Coding extension, referred to as MV-HEVC, and the Scalable Video Coding extension, referred to as SHVC. The MV-HEVC and SHVC extensions share the concept of layered coding, with different layers being included in the encoded video bitstream. Each layer in a coded video sequence is addressed by a unique layer identifier (ID). A layer ID may be present in a header of a NAL unit to identify a layer with which the NAL unit is associated. In MV-HEVC, different layers usually represent different views of the same scene in the video bitstream. In SHVC, different scalable layers are provided that represent the video bitstream in different spatial resolutions (or picture resolution) or in different reconstruction fidelities. The scalable layers may include a base layer (with layer ID=0) and one or more enhancement layers (with layer IDs=1, 2, . . . n). The base layer may conform to a profile of the first version of HEVC, and represents the lowest available layer in a bitstream. The enhancement layers have increased spatial resolution, temporal resolution or frame rate, and/or reconstruction fidelity (or quality) as compared to the base layer. The enhancement layers are hierarchically organized and may (or may not) depend on lower layers. In some examples, the different layers may be coded using a single standard codec (e.g., all layers are encoded using HEVC, SHVC, or other coding standard). In some examples, different layers may be coded using a multi-standard codec. For example, a base layer may be coded using AVC, while one or more enhancement layers may be coded using SHVC and/or MV-HEVC extensions to the HEVC standard.

In general, aspects of the system 100 in FIG. 1A may be used to implement the various techniques described herein for providing luma-driven chroma scaling (LCS) for HDR and WCG contents. As described above, these techniques are related to coding of video signals with HDR and WCG representations. These techniques may specify signaling and operations applied to video data in certain color spaces to enable more efficient compression of HDR and WCG video data. The solutions proposed by the disclosure can therefore improve the compression efficiency of hybrid based video coding systems utilized for coding HDR and WCG video data.

FIG. 1B shows a wireless network 130 that includes a base station 105 and wireless communication devices 115-a and 115-b. The base station 105 provides a coverage 140 that allows both wireless communication devices 115-a and 115-b to communicate with the base station 105 using communication links 125. As described above, encoded video data may be transmitted over a wireless network such as the wireless network 130.

In one scenario, either the wireless communication device 115-a or the wireless communication device 115-b may operate as a source device like the ones described above. In such a scenario, the wireless communication device may encode video data in accordance with the LCS techniques described herein using the encoding device 104 that is part of the wireless communication device. The encoded video data may be transmitted via the wireless network 130 to a destination device.

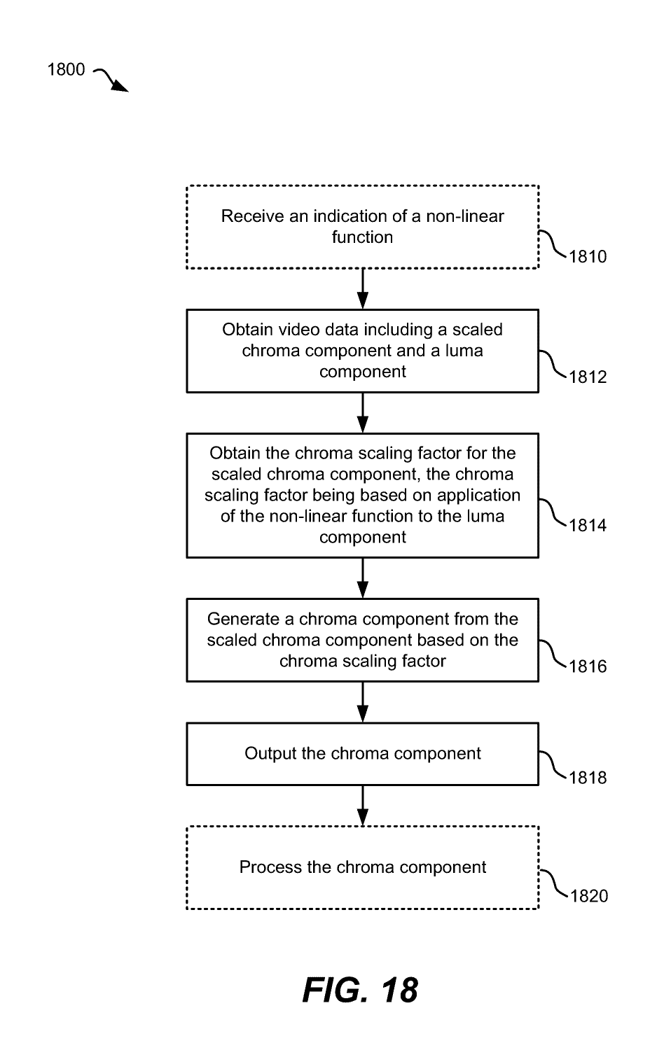

In another scenario, either the wireless communication device 115-a or the wireless communication device 115-b may operate as a destination device like the ones described above. In such a scenario, the wireless communication device may decode video data in accordance with the inverse LCS techniques described herein (e.g., the method 1800 in FIG. 18) using the decoding device 112 that is part of the wireless communication device. The encoded video data may be received via the wireless network 130 from a source device.

In yet another scenario, the wireless communication device 115-a may operate as a source device and the wireless communication device 115-b may operate as a destination device. In such a scenario, the wireless communication device 115-a may encode video data in accordance with the LCS techniques described herein using the encoding device 104 that is part of the wireless communication device 115-a. The wireless communication device 115-b may decode the encoded video data in accordance with the inverse LCS techniques described herein (e.g., FIG. 18) using the decoding device 112 that is part of the wireless communication device 115-b.

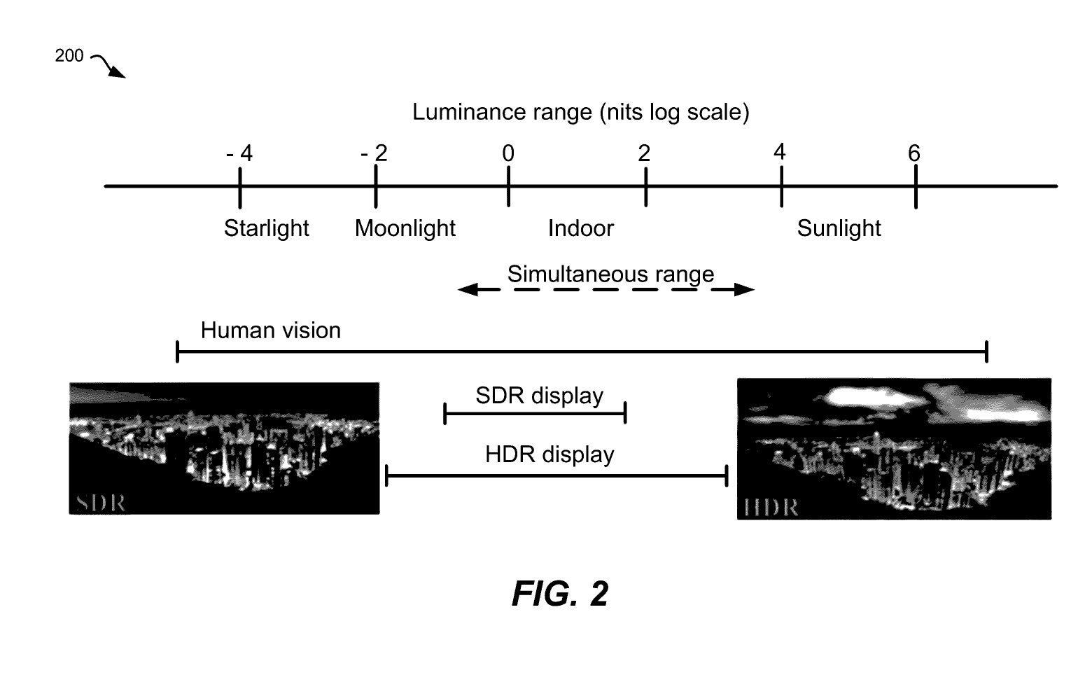

Various aspects of current video applications and services are regulated by ITU-R recommendation BT.709 (also referred to as BT.709 or Rec.709) and provide standard dynamic range (SDR), typically supporting a range of brightness (or luminance) of around 0.1 to 100 candelas (cd) per meter squared (m²) (often referred to as “nits”), which leads to fewer than 10 f-stops. The next generation of video applications and services are expected to provide a dynamic range of up-to 16 f-stops and, although detailed specification is currently under development, some initial parameters have been specified in SMPTE 2084 and ITU-R recommendation BT.2020 (also referred to as Rec.2020). Visualization of dynamic range provided by SDR display of HDTV, expected HDR display of UHDTV and the HVS dynamic range are illustrated by diagram 200 in FIG. 2 along with a luminance range that covers starlight on one end of the range and sunlight at the other end of the range.

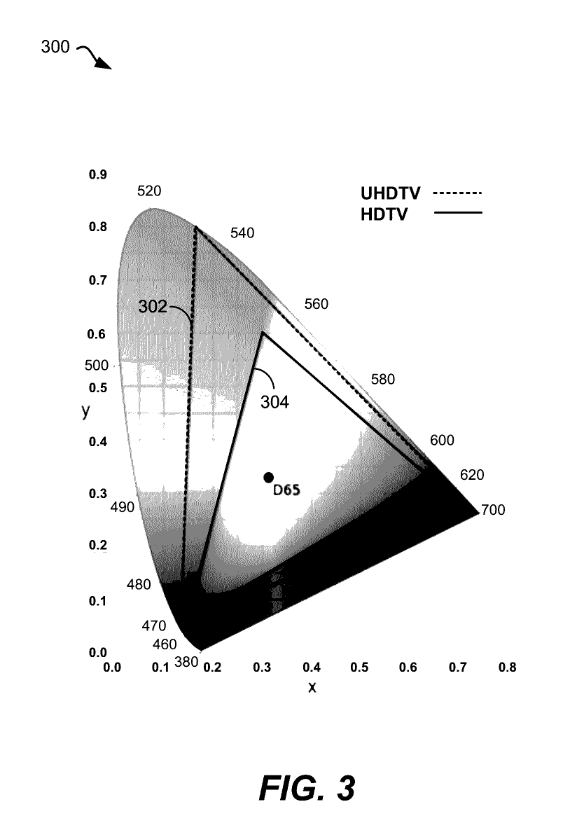

Color gamut and its representation provide another aspect (e.g., color dimension) for a more realistic video experience in addition to HDR. Diagram 300 in FIG. 3 shows a visualization of different color gamut representations. For example, the SDR color gamut for HDTV is indicated by triangle 304 based on the BT.709 color red, green and blue color primaries. The wider color gamut for UHDTV is indicated by triangle 302 based on the ITU recommendation BT.2020 (also referred to as BT.2020 or Rec.2020) color red, green, and blue color primaries. FIG. 3 also depicts the so-called spectrum locus (delimited by the tongue-shaped area), representing limits of the natural colors. As illustrated by FIG. 3, moving from BT.709 to BT.2020 color primaries aims to provide UHDTV services with about 70% more colors. The point designated as D65 in FIG. 3 specifies the white color for given specifications. A few examples of color gamut specification are shown in TABLE 1 below.

TABLE 1
Color Gamut Parameters
RGB Color Space Parameters

| Color | White Point | | Primary Colors | | | | | |
|---|---|---|---|---|---|---|---|---|
| Space | xW | yW | xR | yR | xG | yG | xB | yB |
| DCI-P3 | 0.314 | 0.351 | 0.680 | 0.320 | 0.265 | 0.690 | 0.150 | 0.060 |
| ITU-R | 0.3127 | 0.3290 | 0.64 | 0.33 | 0.30 | 0.60 | 0.15 | 0.06 |
| BT.709 | | | | | | | | |
| ITU-R | 0.3127 | 0.3290 | 0.708 | 0.292 | 0.170 | 0.797 | 0.131 | 0.046 |
| BT.2020 | | | | | | | | |

There may be various representations of HDR video data. The HDR/WCG video data is typically acquired and stored at a very high precision per component (even floating point), using the 4:4:4 chroma format and a very wide color space (e.g., XYZ). The chroma format identifies a subsampling scheme including three parts that describe the number of samples for luminance (e.g., brightness) and chrominance (e.g., color information). The representation described above targets high precision and is (almost) mathematically lossless. However, this type of video data format may feature a lot of redundancies and may not be optimal for compression purposes. A lower precision format with HVS-based assumption is typically used for video applications.

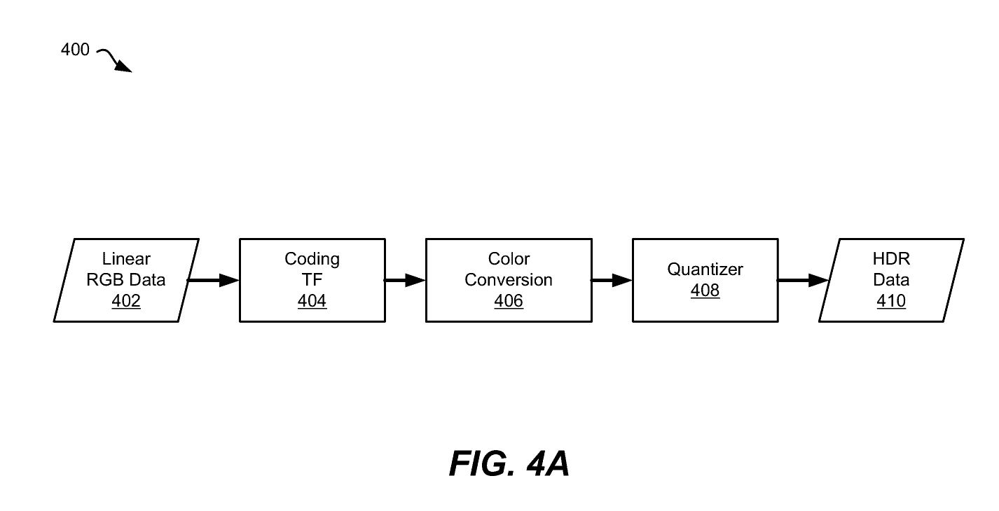

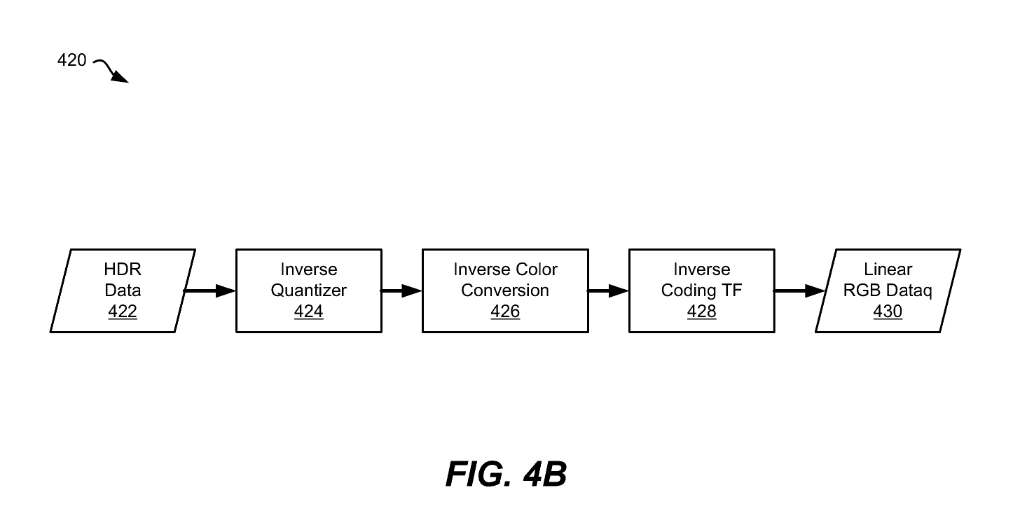

Typical video data format conversion for purposes of compression includes 3 major elements (represented in the block diagrams 400 and 420 in FIGS. 4A and 4B, respectively):
Non-linear transfer function (TF) for dynamic range compacting
Color Conversion to a more compact or robust color space
Floating-to-integer representation conversion (Quantization)

FIGS. 4A and 4B show data format conversion at the encoder (e.g., encoding device 104 in FIG. 1A) and the decoder (e.g., decoding device 112 in FIG. 1), respectively. For encoding, the converted HDR data is fed into any coding tool such as HEVC and then stored (or transmitted) in a compact representation. In the example shown in FIG. 4A, a linear red, green, blue (RGB) data 402 is provided to a coding transfer function (TF) 404, which in turn provides an output to a color conversion (CC) 406 followed by a quantizer 408 to perform bit-depth conversion that results in the HDR data 410. At the decoder side, the decoded HDR data is converted back to linear RGB to be realized at the target display. In the example shown in FIG. 4B, an HDR data 422 is provided to an inverse quantizer 424 to perform bit-depth conversion, which in turn provides an output to an inverse color conversion 426 followed by an inverse coding TF 428 that results in the linear RGB data 430.

The conversion of linear RGB data to HDR data illustrated in FIG. 4A may be performed before encoding the HDR data using, for example, the encoder engine 106 in the encoding device 104 shown in FIG. 1A. Similarly, the conversion of HDR data to linear RGB data illustrated in FIG. 4B may be performed after decoding of the HDR data using, for example, the decoder engine 116 in the decoding device 112 shown in FIG. 1A.

The process illustrated by FIG. 4A shows how the high dynamic range of input RGB data in linear and floating point representation may be compacted by using a non-linear transfer function TF (coding TF 404), e.g., PQ TF as defined in SMPTE 2084. Following this initial processing operation, the RGB data may be converted by color conversion 406 to a target color space more suitable for compression, e.g., the YCbCr color space. After color conversion, the video data may be quantized by quantizer 408 to achieve a certain integer representation, e.g., 10 bit representation. Each of the processing components and the order in which they are configured as shown in FIG. 4A is given by way of example and may vary in different applications. For example, the color conversion operation may precede the coding TF operation. The process illustrated by FIG. 4B shows the inverse of the operations described above with respect to FIG. 4A, resulting in linear RGB data. Similarly, each of the processing components and the order in which they are configured as shown in FIG. 4B is given by way of example and may vary in different applications.

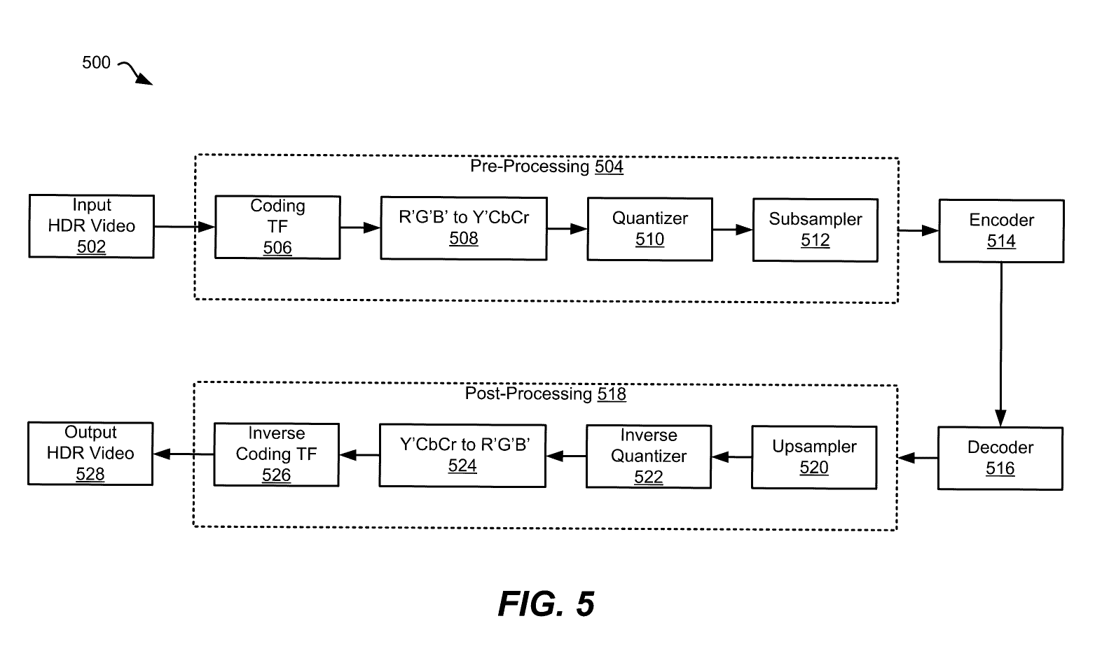

FIG. 5 shows a block diagram 500 that illustrates an example of encoding and decoding chains using RGB linear light. While this example corresponds to a reference system defined in MPEG that uses an HEVC codec with Main10 profile, aspects of this example may be applicable to systems that use coding and/or decoding operations different from those of an HEVC codec. Moreover, aspects of this example provide additional details that may be applicable to the encoding chain described in connection with FIG. 4A and the decoding chain described in connection with FIG. 4B.

For example, FIG. 5 shows an encoding chain that includes an input HDR video 502 corresponding to RGB data as defined in BT.709/2020. The encoding chain also includes a pre-processing 504 having a coding TF 506, a color conversion from R′G′B′ to Y′CbCr 508, a quantizer 510, and a subsampler 512. The subsampler 512 may subsample from a 4:4:4 chroma format to a 4:2:0 chroma format, for example. Following the pre-processing 504, the encoding chain may include an encoder 514. In an example, the encoder 514 may be an HEVC encoder that processes 10 bit samples in 4:2:0 chroma format.

FIG. 5 also shows a decoding chain that includes a decoder 516. In an example, the decoder 516 may be an HEVC decoder that processes 10 bit samples in 4:2:0 chroma format. The decoding chain also includes a post-processing 518 having an upsampler 520, an inverse quantizer 522, an inverse color conversion from Y′CbCr to R′G′B′ 524, and an inverse coding TF 526. The upsampler 520 may upsample from a 4:2:0 chroma format to a 4:4:4 chroma format, for example. The decoding chain may also include an output HDR video 528 corresponding to RGB data as defined in BT.709/2020.

The coding transfer function, the color conversion or color transform, and the quantization described above with respect to FIGS. 4A, 4B, and 5, are described in more detail below.

The transfer function (TF) may be applied to the linear data to compact its dynamic range and make it possible to represent it with limited number of bits. This transfer function is typically a one-dimensional (1D) non-linear function that corresponds to the inverse electro-optical transfer function (OETF) of the end-user display as specified for SDR in Rec.709 or that approximates the HVS perception to brightness changes as for PQ TF specified in SMPTE 2084 for HDR. The inverse process of the OETF is the EOTF (electro-optical transfer function), which maps the code levels back to luminance.

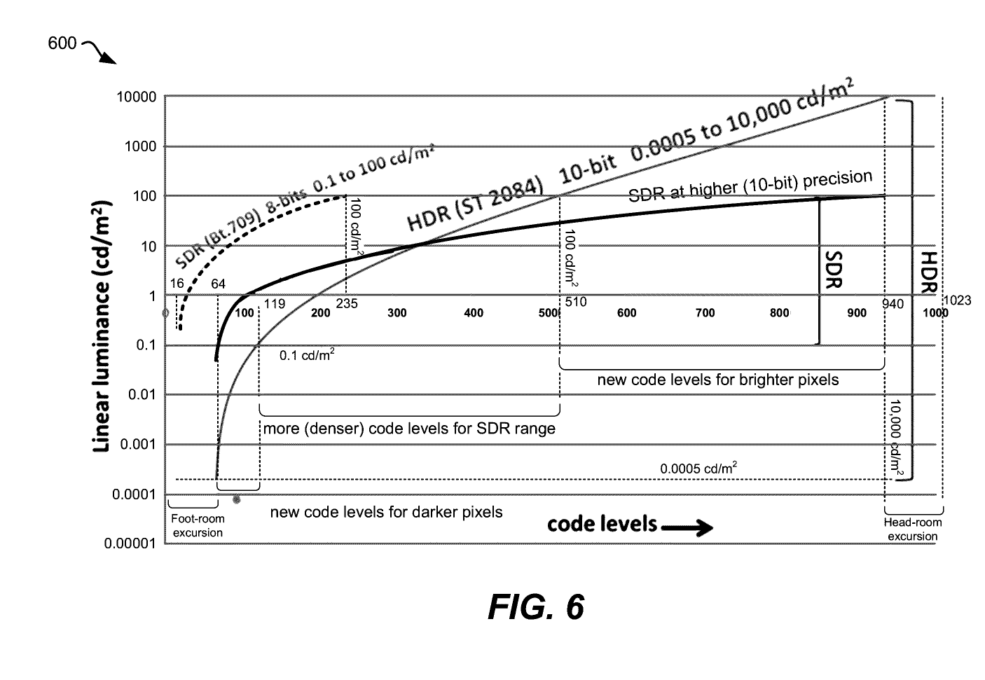

Diagram 600 in FIG. 6 shows several examples of transfer functions. As illustrated in FIG. 6, the transfer functions provide a way for mapping linear luminance (cd/m²) to code levels. For example, three different transfer functions are illustrated. One for SDR (BT/709) using 8 bits and ranging from 0.1 cd/m² to 100 cd/m², another for HDR (SMPTE 2084) using 10 bits and ranging from 0.0005 cd/m² to 10,000 cd/m², and yet another for SDR at higher 10 bit precision. The HDR transfer function can map linear luminance to code levels for darker pixel than those in SDR, can provide more (denser) code levels for the SDR range, and can provide code levels for brighter pixel than those covered by SDR. These mappings may be applied to each linear R, G and B component separately.

With respect to the color conversion or color transform, RGB data is typically used as input because RGB data is what is produced by image capturing sensors. However, the RGB color space has high redundancy among its components and it may not be optimal for compact representation. To achieve a more compact and robust representation, the RGB components are generally converted to a more uncorrelated color space that is suitable for compression, e.g., the YCbCr color space, where Y is the luma component, Cb is the blue-difference chroma component, and Cr is the red-difference chroma component. This color space separates the brightness in the form of luminance and color information in different un-correlated components. This color space is sometimes referred to as Y′CbCr, Y Pb/Cb Pr/Cr, YCBCR, or Y′ C_{B}C_{R}.

For modern video coding systems, the color space that is typically used is YCbCr as specified in BT.709. The YCbCr color space in BT.709 standard specifies the conversion process from R′G′B′ to Y′CbCr (non-constant luminance representation) described below with respect to Equation (1).

$${Y}^{′} = 0.2126 * {R}^{′} + 0.7152 * {G}^{′} + 0.0722 * {B}^{′} \\ Cb = \frac{{B}^{′} - {Y}^{′}}{1.8556} \\ Cr = \frac{{R}^{′} - {Y}^{′}}{1.5748} \qquad ( 1 )$$

The conversion process described above can also be implemented using Equation (2) below, which describes an approximate conversion that avoids the division for the Cb and Cr components.

Y′=0.212600*R′+0.715200*G′+0.072200*B′

Cb=−0.114572*R′−0.385428*G′+0.500000*B′

Cr=0.500000*R′−0.454153*G′−0.045847*B′ (2)

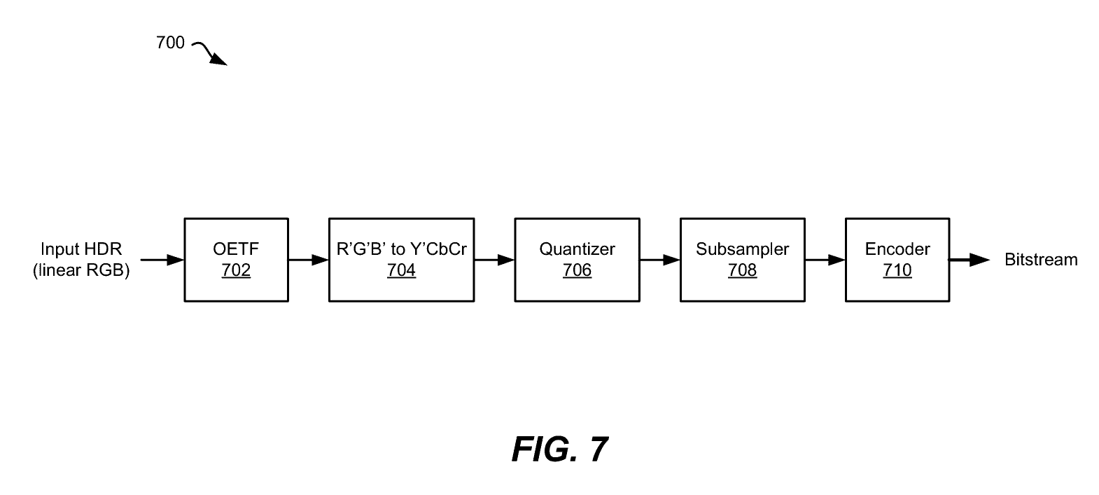

BT.2020 specifies the two different ways to perform the conversion process from R′G′B′ to Y′CbCr. The first approach is based on constant-luminance (CL) and the second approach is based on non-constant luminance (NCL). Diagram 700 in FIG. 7 shows an example of the NCL approach in which the conversion from R′G′B′ to Y′CbCr is applied after OETF. The NCL approach may be performed based on the conversion described below in Equation (3).

$${Y}^{′} = 0.2627 * {R}^{′} + 0.6780 * {G}^{′} + 0.0593 * {B}^{′} \\ Cb = \frac{{B}^{′} - {Y}^{′}}{1.8814} \\ Cr = \frac{{R}^{′} - {Y}^{′}}{1.4746} \qquad ( 3 )$$

In the encoding chain shown in FIG. 7, high dynamic range video data (e.g., linear RGB video data) is provided as input to an OETF 702 to perform an inverse electro-optical transfer function. The compacted video data produced by the OETF 702 is then provided to a color conversion operation 704 that performs color conversion or transformation from R′G′B′ to Y′CbCr. After the conversion, the video data in the new color space is quantized (e.g., bit-depth conversion) by quantizer 706, which is followed by subsampling at the subsampler 708. In an example, the subsampler 708 may change the chroma format from 4:4:4 to 4:2:0. The output from the subsampler 708 may be provided to an encoder 710 to generate a bitstream having encoded video data. In an example, the encoder 710 may be an HEVC encoder that operates on 10 bit samples in 4:2:0 chroma format. Although not shown in FIG. 7, an inverse operation may be performed by a decoding chain where the color conversion is from Y′CbCr to R′G′B′, and where the inverse transfer function is performed by using an EOTF.

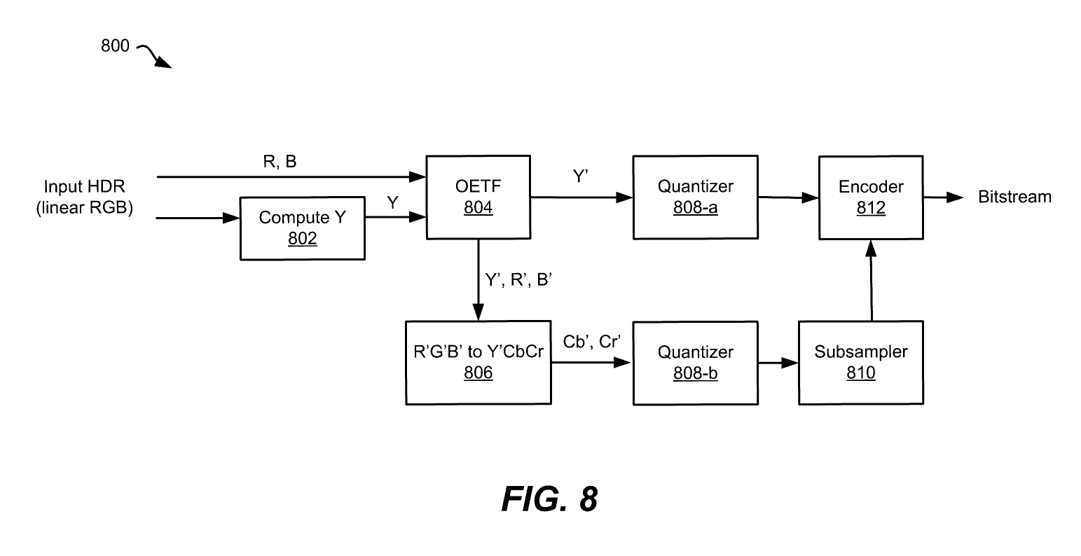

Diagram 800 in FIG. 8 shows an example of an encoding chain used in the CL approach for generating Y′CbCr. In this example, to generate Y′ (luma) the value of the luminance (Y) is first computed by the compute Y 802 operation from red (R), green (G), and blue (B) in linear light. The values of Y, R, and B are provided to an OETF 804 to produce Y′ from Y, and to produce R′ and B′ from R and B, respectively. The two chroma components, Cb′ and Cr′, are computed or determined from Y′, R′, and B′ by color conversion 806 (e.g., color space conversion from R′G′B′ to Y′Cb′Cr′). Aspects of the color conversion are performed in accordance with Equation (4).

$${Y}^{′} = TF ( 0.2627 * R + 0.6780 * G + 0.0593 * B ) \\ {Cb}^{′} = \{ \begin{matrix}\frac{{B}^{′} - {Y}^{′}}{1.9404} , & - 0.9702 \leq {B}^{′} - {Y}^{′} < 0 \\ \frac{{B}^{′} - {Y}^{′}}{1.5816} , & 0 < {B}^{′} - {Y}^{′} \leq 0.7908\end{matrix} \\ {Cr}^{′} = \{ \begin{matrix}\frac{{R}^{′} - {Y}^{′}}{1.7184} , & - 0.8592 \leq {R}^{′} - {Y}^{′} < 0 \\ \frac{R - {Y}^{′}}{0.9936} , & 0 < {R}^{′} - {Y}^{′} \leq 0.4968\end{matrix} \qquad ( 4 )$$

Quantizers 808-a and 808-b may be substantially similar in operation to the quantizer 706 in FIG. 7. Similarly, the subsampler 810 and the encoder 812 may be substantially similar to the subsampler 708 and the encoder 720 in FIG. 7, respectively. Although not shown in FIG. 8, an inverse operation may be performed by a decoding chain.

It should be noted that Equations (3) and (4) above are based on BT.2020 color primaries and the OETF specified in BT.2020. Thus, if a different OETF and/or color primaries are used, the numerical parameters used in Equations (3) and (4) may be different to correspond to the OETF and/or color primaries being used. Moreover, both color spaces in the operation remain normalized, therefore, for the input values normalized in a range [0 . . . 1], the resulting values in the color conversion will be mapped to a range [0 . . . 1]. Generally, color conversions or transforms implemented with floating point accuracy can provide perfect reconstruction, thus the color conversion or transform processes described above can be lossless.

With respect to the quantization or fix point conversion described herein, the video data in the target color space (e.g., Y′CbCr color space) is represented using a high bit-depth (e.g. floating point accuracy) an may need to be converted to a target bit-depth that is more suitable for subsequent handling and/or processing. Various studies have shown that using 10-12 bits of accuracy in combination with the PQ TF is sufficient to provide HDR data of 16 f-stops with distortion below what is referred to a just-noticeable difference. Moreover, video data represented with 10 bits of accuracy can be further coded with most of the state-of-the-art video coding solutions. This quantization is an element of lossy coding and is a source of inaccuracy introduced to the converted data. The inverse quantization performed by the various inverse quantizers described herein is also used to implement a bit-depth conversion operation, one that typically receives 10-12 bits of accuracy to be converted to a target with a higher bit-depth.

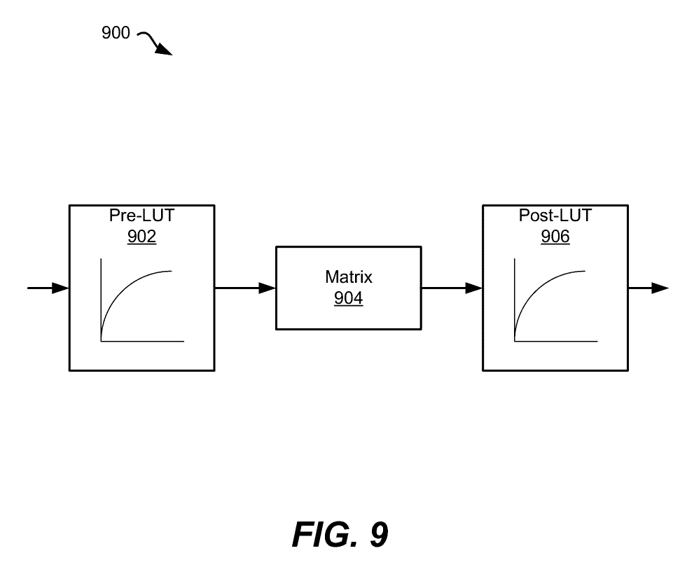

As part of the mapping that occurs from one color space to another color space, supplemental enhancement information (SEI) messages may be used. For example, one type of SEI message is a color remapping information (CRI) SEI message. A CRI SEI message may be defined in the HEVC standard and may be used to convey or indicate information for mapping pictures from one color space to another color space. As shown in diagram 900 in FIG. 9, a representative structure of the syntax of the CRI SEI message may include or indicate three parts or information: a first look-up table (Pre-LUT) 902, a matrix 904 indicating color remapping coefficients, and a second look-up table (Post-LUT) 906. In an aspect, the matrix 904 may be a 3×3 matrix but other matrix sizes may also be used. For each color component, e.g., R, G, B or Y, Cb, Cr, separate or independent LUTs may be defined for both the Pre-LUT 902 and the Post-LUT 906. The CRI SEI message may also include a syntax element called color_remap_id, where different values of this syntax element may be used to indicate different purposes of the CRI SEI message.

Another type of SEI message is a dynamic range adjustment (DRA) SEI message. The DRA SEI message may include an indication or signaling of a set of scale and offset numbers that may be used for mapping input samples. The DRA SEI message may be configured to allow the signaling of different look-up tables for different color components, and may also be configured to allow for signaling optimization when the same scale and offset are to be used for more than one color component. The scale and offset numbers may be signaled in fixed length accuracy. The DRA SEI message has not yet been adopted as part of a video coding standard. In an aspect, the DRA SEI message may be used for some of the signaling techniques described below.

As noted above, next generation video applications are expected to operate with video data that represents scenery captured in high dynamic range (HDR) and wide color gamut (WCG) conditions. Processing of video data with HDR and WCG may pose some technical challenges. For example, MPEG defines as a reference or anchor system a system that uses an HEVC codec with Main10 profile. However, such a reference system tends to exhibit noticeable color artifacts even at reasonably high bitrate for most of sequences of interest. A color artifact may refer to a noticeable distortion in the color representation of a video image as a result of processing operations performed on the video image. Since color artifacts can be as visible to a user as coding artifacts (e.g., blocking and ringing artifacts), removing color artifacts may be considered a critical issue to be addressed.

One solution to address the presence of color artifacts in HDR and WCG video data is to enhance chroma information by scaling, e.g., adjusting Cb and/or Cr with scaling factors larger than 1. The adjusting of the chroma components may typically involve multiplying a current value of the chroma components by a scaling factor during the video data encoding process. This solution generates or produces stretched chroma information that has a range wider than the original range of the chroma information. For example, the original values for Cb and Cr can be scaled with scaling factors, S_{Cb} and S_{Cr}, respectively, as illustrated below in Equation (5).

Cb′=S_{Cb}Cb, where S_{Cb}>1

Cr′=S_{Cr}Cr, where S_{Cr}>1 (5)

During the decoding process, the inverse operation is applied to recover the original values for Cb and Cr by adjusting the scaled values Cb′ and Cr′ with the scaling factors, S_{Cb} and S_{Cr}, respectively, as illustrated below in Equation (6). The adjusting during the decoding process may involve dividing Cb′ and Cr′ respectively by S_{Cb} and S_{Cr}.

$$Cb = \frac{{Cb}^{′}}{{S}_{Cb}} , where {S}_{Cb} > 1 \\ Cr = \frac{{Cr}^{′}}{{S}_{Cr}} , where {S}_{Cr} > 1 \qquad ( 6 )$$

It is to be understood that the operations described in Equations (5) and (6) may be performed using multiplication or division, whichever may provide a more efficient computation.

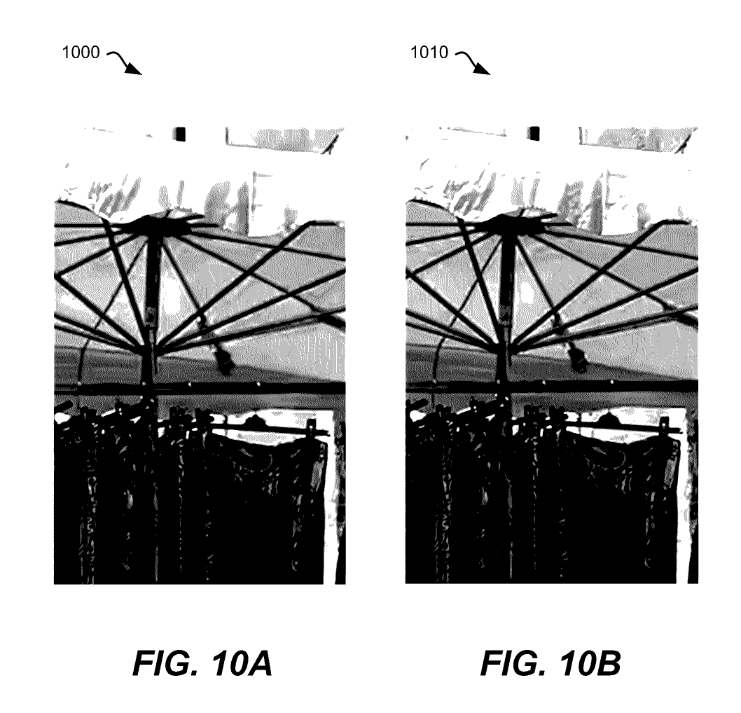

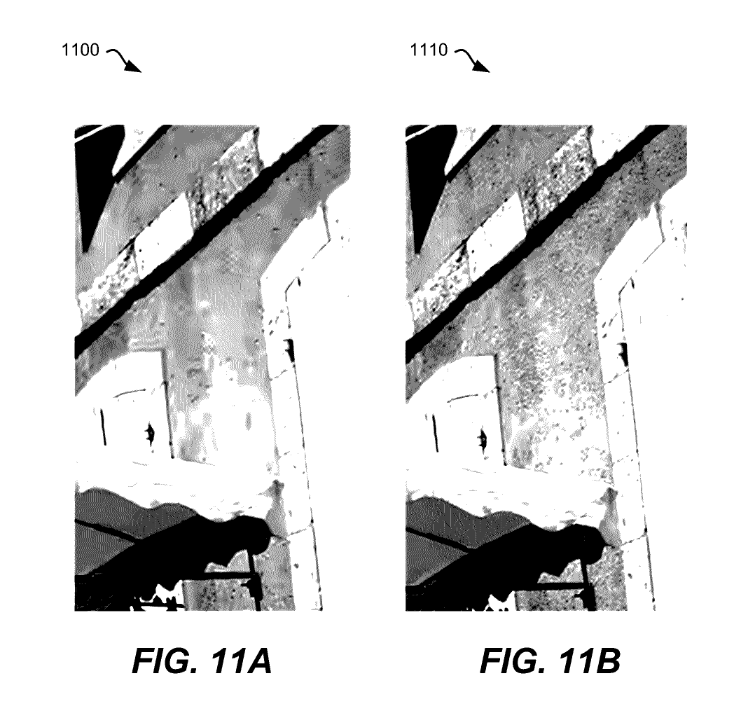

The approach described above for chroma scaling does not take into account any other side information, e.g., luma (Y′), and “blindly” scales up chroma information, e.g., Cb and Cr. FIGS. 10A, 10B, 11A, and 11B show examples of blind chroma scaling application to Cb and Cr chroma components in BT.2020. Diagram 1000 in FIG. 10A and diagram 1100 in FIG. 11A represent anchor images to show the visual quality improvement of an HDR test sequence (in HD resolution) and coded a 1.3 Mbps after the application of blind chroma scaling. Diagram 1010 in FIG. 10B and diagram 1110 in FIG. 11B represent the corresponding MPEG CfE response using blind chroma scaling. By allocating more codewords for chroma components (or equivalently, fewer codewords for luma), there is a noticeable visual quality improvement resulting from the removal of color artifacts.

Applying a single scaling factor to each chroma component, e.g., Cb and Cr, as described above in connection with Equations (5) and (6) could lead to wasteful use of codewords or to the loss of accuracy of color information because blind chroma scaling, by nature, assigns the same amount of codewords no matter what the brightness levels may be. Accordingly, there is a need to improve on blind chroma scaling and to address the fact that human vision (e.g., HVS) is not equally sensitive to colors having the same chroma information but with different brightness levels. The perception of colors in low brightness levels is quite limited and, therefore, the application of chroma scaling that depends on the level of brightness can provide improvements in the process of removing color artifacts.

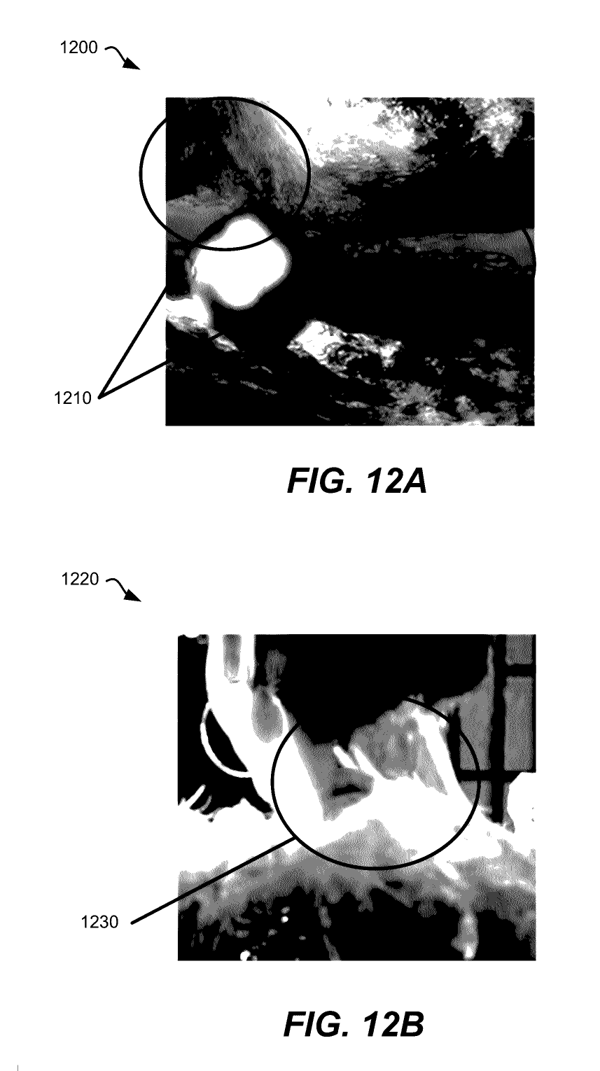

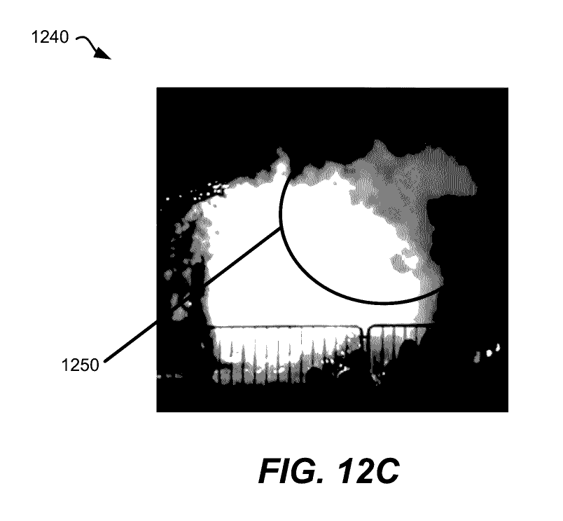

One simple approach to modify blind chroma scaling may be to perform selective blind chroma scaling. That is, blind chroma scaling may be applied only in those scenarios in which the brightness level is determined to be larger than a certain threshold. For example, the Cb and Cr chroma components may be scaled up when the value of the Y′ component is greater than a threshold, Y′_{TH}. This approach, however, may end up causing visible color artifacts because of the compression error on the Y′ component at post-processing, especially when the given value of the Y′ component is close to Y′_{TH}. FIG. 12A shows a diagram 1200 in which visible color artifacts 1210 result from the use of selective blind chroma scaling. Similarly, FIG. 12B and FIG. 12C show diagrams 1220 and 1240 in which visible color artifacts 1230 and 1250, respectively, result from the use of selective blind chroma scaling. The techniques and systems described in connection with this disclosure include methods to enhance chroma information by exploiting brightness level information, which leads to better visual quality without such visible color artifacts. In particular, the present disclosure provides techniques in which luma-driven chroma scaling (LCS) is used when processing HDR and WCG content in video data to improve the visual quality of the video data.

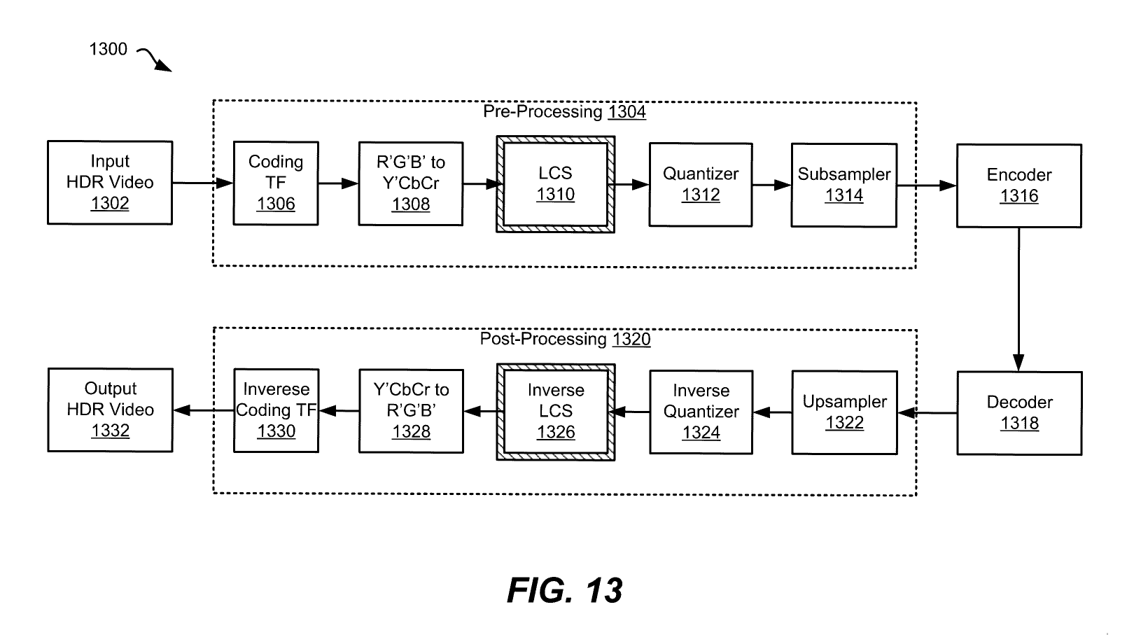

To achieve better HDR quality, LCS changes, modifies, or adjusts the scaling factors for chroma components by using smoothly-varying functions. FIG. 13 shows a block diagram 1300 that illustrates a simplified example of encoding/decoding chains with LCS. During the encoding process, Y′, Cb, and Cr are provided as an input to the LCS operation, which in turn converts Cb and Cr into Cb′ and Cr′ during pre-processing. During post-processing in the decoding process, reconstructed Y′, Cb′, and Cr′ are converted back to Y′, Cb, and Cr by the inverse LCS. Equations (7) and (8) below describe how (forward) LCS and inverse LCS are formulated with chroma scaling factors, S_{Cb} and S_{Cr}, driven by the luma component, Y′.

### Forward LCS (or LCS):

Cb′(x,y)=S_{Cb}(Y′(x,y))Cb(x,y),

Cr′(x,y)=S_{Cr}(Y′(x,y))Cr(x,y) (7)

### Inverse LCS:

$$Cb ( x , y ) = \frac{{Cb}^{′} ( x , y )}{{S}_{Cb} ( {Y}^{′} ( x , y ) )} , Cr ( x , y ) = \frac{{Cr}^{′} ( x , y )}{{S}_{Cr} ( {Y}^{′} ( x , y ) )} \qquad ( 8 )$$

FIG. 13 is substantially similar to FIG. 5 described above, with the addition of an LCS 1310 in the encoding chain and an inverse LCS 1326 in the decoding chain. For example, an encoding chain includes an input HDR video 1302 corresponding to RGB data as defined in BT.709/2020. The encoding chain also includes a pre-processing 1304 having a coding TF 1306, a color conversion from R′G′B′ to Y′CbCr 1308, the LCS 1310, a quantizer 1312, and a subsampler 1314. The subsampler 1314 may subsample from a 4:4:4 chroma format to a 4:2:0 chroma format, for example. Following the pre-processing 1304, the encoding chain may include an encoder 1316. In an example, the encoder 1316 may be an HEVC encoder that processes 10 bit samples in 4:2:0 chroma format.

FIG. 13 also shows a decoding chain that includes a decoder 1318. In an example, the decoder 1318 may be an HEVC decoder that processes 10 bit samples in 4:2:0 chroma format. The decoding chain also includes a post-processing 1320 having an upsampler 1322, an inverse quantizer 1324, the inverse LCS 1326, an inverse color conversion from Y′CbCr to R′G′B′ 1328 and an inverse coding TF 1330. The upsampler 1322 may upsample from a 4:2:0 chroma format to a 4:4:4 chroma format, for example. The decoding chain may also include an output HDR video 1332 corresponding to RGB data as defined in BT.709/2020.

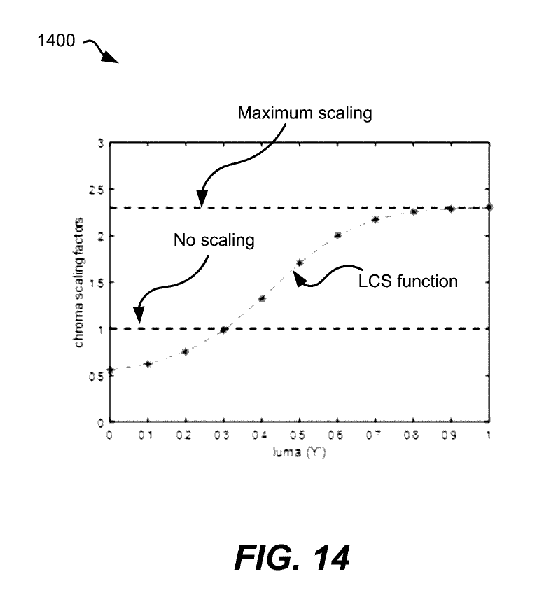

The chroma scaling factors are the output of functions taking luma or the luma component, Y′, as an input, S_{Cb}(Y′) and S_{Cr}(Y′), hereafter called an “LCS function”. For a given pixel located at (x, y), the pixel's chroma components, Cb(x, y) and Cr(x, y), are scaled with factors computed by LCS functions that take the luma component value as an input, Y′(x, y). FIG. 14 shows a diagram 1400 that illustrates an example of an LCS function that smoothly changes with respect to luma, Y′, within the range of [0, 1]. With the LCS function in the example, chroma components of pixels with smaller values of luma are multiplied by smaller scaling factors. The LCS functions S_{Cb}(Y′) and S_{Cr}(Y′) can be optimally selected for target applications. For example, the LCS functions can be empirically or theoretically derived functions, fixed (throughout sequences) or varying (over sequences, frames, scenes) functions, color-gamut dependent functions. As illustrated in FIG. 14, the LCS function may reach a maximum scaling value for higher luma (e.g., luma close to 1) and may take scaling values less than one for lower luma (e.g., luma close to 0).

Below are provided various aspects related to the derivation or calculation of LCS functions that may be used for the techniques described herein. In a first aspect, the LCS functions may be derived or determined as functions of Y′ only, e.g., S_{Cb}(Y′) and S_{Cr}(Y′). That is, the LCS functions are based only on the luma value of the pixel and no other information.

In another aspect, the LCS functions may depend or be based on one or more parameters other than luma, Y′. The parameters may include color gamut, color primaries, the sign of bi-polar chroma components, or the statistics of each chroma component. The additional parameters may be applied independently, or in a combination. For example, the LCS functions may be based on luma, Y′, and one or more of these additional parameters.

In yet another aspect, the LCS functions may extend to consider chroma information, e.g., Cb and Cr, as well as luma information, e.g., Y′. For example, given a pixel, P(x, y), the LCS functions may depend on Y′(x, y), Cb(x, y), and/or Cr(x, y) to derive or obtain a scaling factor. The dependency may include each of the components, or a combination of them. For example, the LCS function may be based on luma information and on the information of one or both of the chroma components. In this regard, the LCS functions may be derived such that they enhance a range of color that is represented by certain ranges of Y′, Cb, and Cr, e.g., gray color that frequently shows color artifacts in MPEG test sequences.

In another aspect, the LCS functions, e.g., S_{Cb}(Y′) and S_{Cr}(Y′), may be fixed throughout all the target sequences. On the other hand, the LCS functions may vary every frame(s), scene(s), or sequence(s) either by manually-tuned cycles or by checking that certain conditions are satisfied, e.g., certain conditions are met that are based on average brightness of target pixels or distribution of luma and (or) chroma components.

In another aspect, the LCS functions used in pre-processing may be based on luma, e.g., Y′, that results from the color conversion to the target color coordinates, e.g., conversion from R′G′B′ to Y′CbCr. For post-processing, the decoded luma, Y′, may be first reconstructed then fed into the inverse LCS to reconstruct the chroma components.

In yet another aspect, the LCS functions used in pre-processing may be based on luma, Y′, that is adjusted by one or more procedures. An example of such procedures may be dynamic range adjustment (DRA) on luma. For proper reconstruction, post-processing may first apply the inverse LCS to recover chroma components then the decoded luma component is inversely processed for reconstruction.

In another aspect, the LCS functions may be monotonically non-decreasing. That is, the LCS functions may have larger scaling values for larger values of the corresponding luma. Depending on the application requirements, the LCS functions need not necessarily increase monotonically. An example of a non-monotonically increasing function may be a bell-shaped function with a peak in the middle of the range.

In yet another aspect, the LCS functions may use as input the luma, Y′, of non-constant luminance (NCL) or of constant luminance (CL).

In another aspect, the LCS functions may be implemented or conveyed in the form of a closed expression, as a 1-D look-up table (LUT), or as combinations of piece-wise linear/polynomial functions.

The LCS functions described above may be applied in different ways in accordance with the techniques described herein. For example, in a first aspect, the LCS functions, e.g., S_{Cb}(Y′) and S_{Cr}(Y′), may be used to derive the scaling factors for chroma components in floating domain as a function of the luma (or processed luma), e.g., Cb and Cr with the range of [−0.5, 0.5] and Y′ with the range of [0, 1]. The LCS functions may be used to derive, obtain, or otherwise calculate the scaling factors for the chroma components in integer domain with a given bit depth, e.g., Y′, Cb, and Cr with the range of [0, 2̂(bitDepth)−1].

In another aspect, the LCS functions may be applied to chroma components without down-sampling, e.g., YCbCr in 4:4:4 chroma format, in either floating- or integer-domain. When no down-sampling operation is applied to the chroma samples, a chroma scaling factor for the pixel positioned at (x, y) may be computed by the LCS function that takes the value of corresponding (co-located) luma as an input, Y′(x, y).

In yet another aspect, the LCS functions may be applied to down-sampled chroma components in either floating- or integer-domain, e.g., YCbCr in 4:2:0 chroma format. For the down-sampled chroma components, the scaling factors may be computed either with co-located luma, e.g. Y′(2x, 2y) for Cb(x, y) in 4:2:0 chroma format, or with a function of the interpolated luma value at position (x, y), e.g., when the chroma component site or position is shifted by half pixel from the luma values in both directions, the interpolated luma value at that site or position (x, y) may derived as the average of four Y′ values as described below in Equation (9):

$$\frac{\begin{matrix}{Y}^{′} ( 2 x , 2 y ) + {Y}^{′} ( 2 x + 1 , 2 y ) + \\ {Y}^{′} ( 2 x , 2 y + 1 ) + {Y}^{′} ( 2 x + 1 , 2 y + 1 )\end{matrix}}{4} \qquad ( 9 )$$

for Cb(x, y) and Cr(x, y) in 4:2:0 chroma format and the upsampling filter used is bilinear. Similar derivation or calculation may be done for more generic filters. In some aspects, the upsampling filter used at the encoder may be signaled to the decoder.

In yet another aspect, the LCS functions may be applied to chroma components without down-sampling, e.g., YCbCr in 4:4:4 chroma format, in either floating- or integer-domain. When no down-sampling operation is applied to the chroma samples, a chroma scaling factor for the pixel positioned at position (x, y) may be computed by the LCS function that takes the value of corresponding (co-located) luma as an input, Y′(x, y).

In another aspect, an LCS function may be applied to a chroma component to introduce a color correction, e.g., in an HDR/WCG application with SDR-backward compatible capabilities. In example of such an aspect, luma samples that are used to derive associated chroma scaling factors may be produced by applying a SDR tone mapping function to luma samples in HDR representation. An estimated shift from applying a tone mapping function to be introduced in Cr and Cb components may be provided through a signaled LCS function.

With respect to parameter signaling, the LCS function, or information about the LCS function, may be signaled as a look-up table (LUT) and the number of bits used to signal the points defining the LUT may also signaled. For sample values in the LCS function that do not have explicit points signaled, the value of such samples may is interpolated based on the neighboring pivot points (e.g., values of neighboring points in the LUT). And, for each signaled LUT, signaling of a component-dependent identifier (ID) may identify the application of the signaled LUT.

In another aspect, the LCS function may be described and signaled in terms of scales and offsets instead of pivot points. And, for each signaled sets of scales and offsets, signaling of a component-dependent ID may identify to what component the scales and offsets are to be applied.

In yet another aspect, signaling of an LCS function, or information associated with an LCS function, need not be limited to the use of an SEI message, such as an LCS SEI message. Other means to signal the parameters associated with one or more LCS functions may include using other SEI messages or methods that may be adopted as part of a video coding standard. The signaling of an LCS function may include signaling component-dependent ID as well as various forms of parameters, such as (3-D) LUT, or a form of scales and offsets, e.g., component scaling SEI message.

In another aspect, the LCS function, or information about the LCS function, may be described and signaled in terms of dynamic range partitions, scales associated with a partition, and global offset instead of pivot points or scale and offset for each partition. At the LUT construction, locally applied scale and offsets parameters may be derived through an associated process at the encoder side (e.g., the encoding device 104 in FIG. 1A) and the decoder side (e.g., the decoding device 112 in FIG. 1A).

Aspects related to the implementation of the various techniques described herein for luma-driven chroma scaling (LCS) in high dynamic range (HDR) and wide color gamut (WCG) video data are described in more detail below.

In some aspects, LCS functions, such as the ones described above, may be derived, obtained, or otherwise determined for BT.709 and DCI-P3(D65 white) gamut in BT. 2020 color primaries with an NCL framework and applied to YCbCr in floating-domain, where no down-sampling is considered. An example of such LCS function is shown below in connection with Equation (10).

$$S = f ( {Y}^{′} ) = \frac{{S}_{max} - 1.0}{( 1 + ( 1 - {Y}^{′} ) {e}^{\frac{- ( {Y}^{′} - {Y}^{*} )}{α}} )} + 1.0 \qquad ( 10 )$$

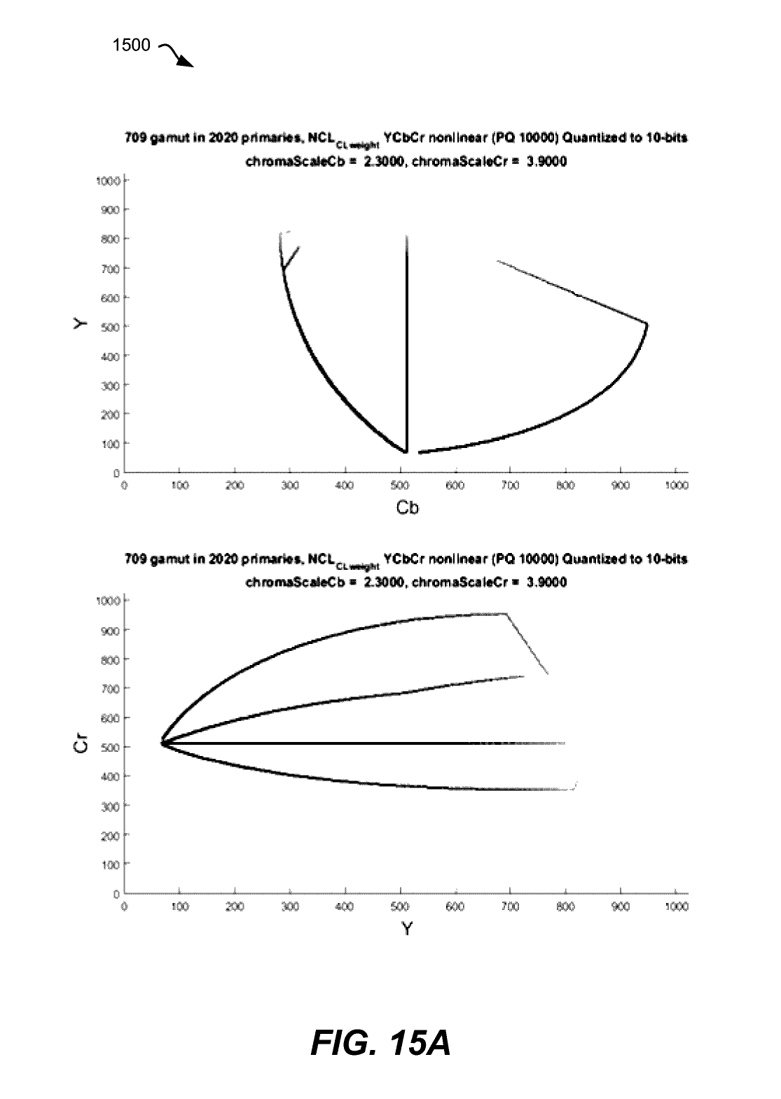

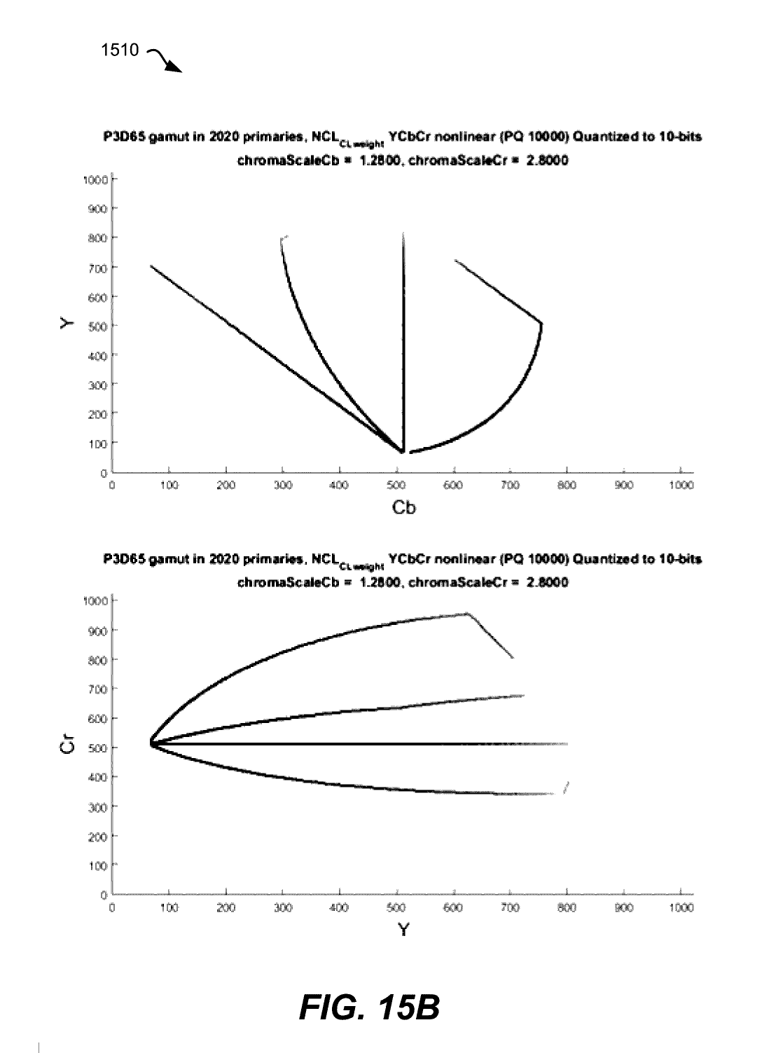

In Equation (10), Sₘₐₓ varies for different color gamut in BT.2020 color primaries, as shown in TABLE 2 below. The maximum scaling factors stretches Cb and Cr close to the allowed extent without clipping. With those maximum scaling factors, Sₘₐₓ, as shown in FIGS. 15A and 15B, illustrate how Cb and Cr are distributed for different gamuts.

TABLE 2
Sₘₐₓ for BT.709 and DCI-P3 (D65 white)
gamut in BT.2020 color primaries

| Gamut | Smax |
|---|---|
| BT.709 | 2.3 for Cb/3.9 for Cr |
| DCI-P3 (D65 White) | 1.2 for Cb/2.8 for Cr. |

For example, diagram 1500 in FIG. 15A illustrates a visualization of Cb and Cr with Sₘₐₓ for BT.709 gamut in BT.2020. On the other hand, diagram 1510 in FIG. 15B illustrates a visualization of Cb and Cr with Sₘₐₓ for DCi-P3 (D65 white) gamut in BT.2020.

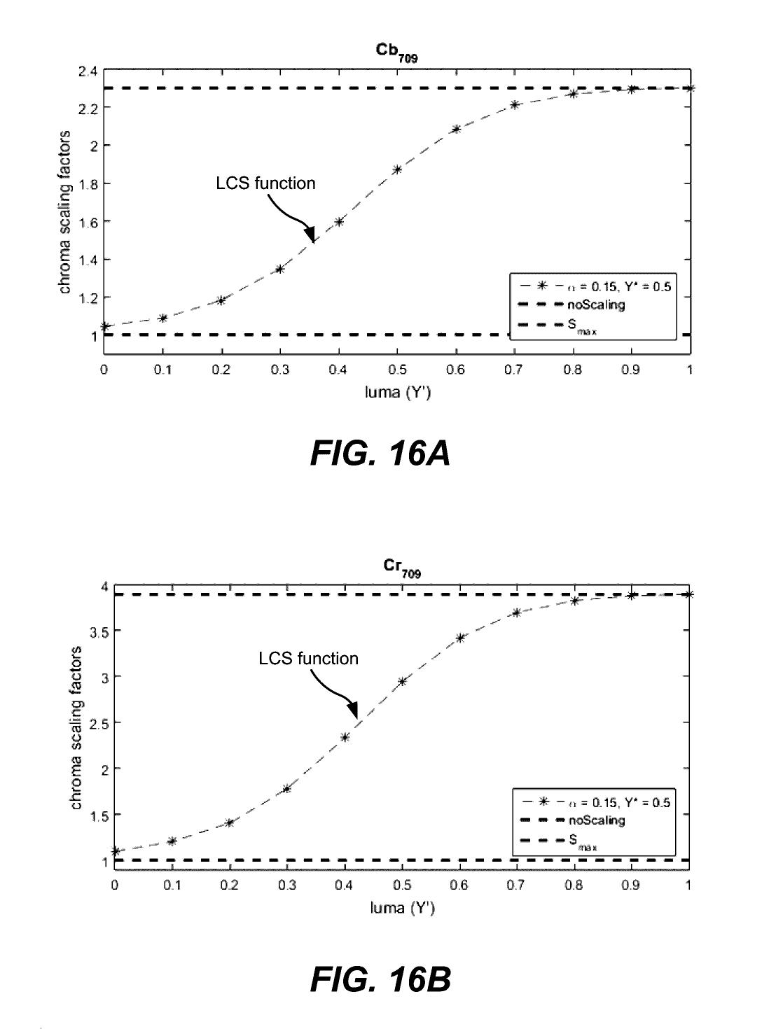

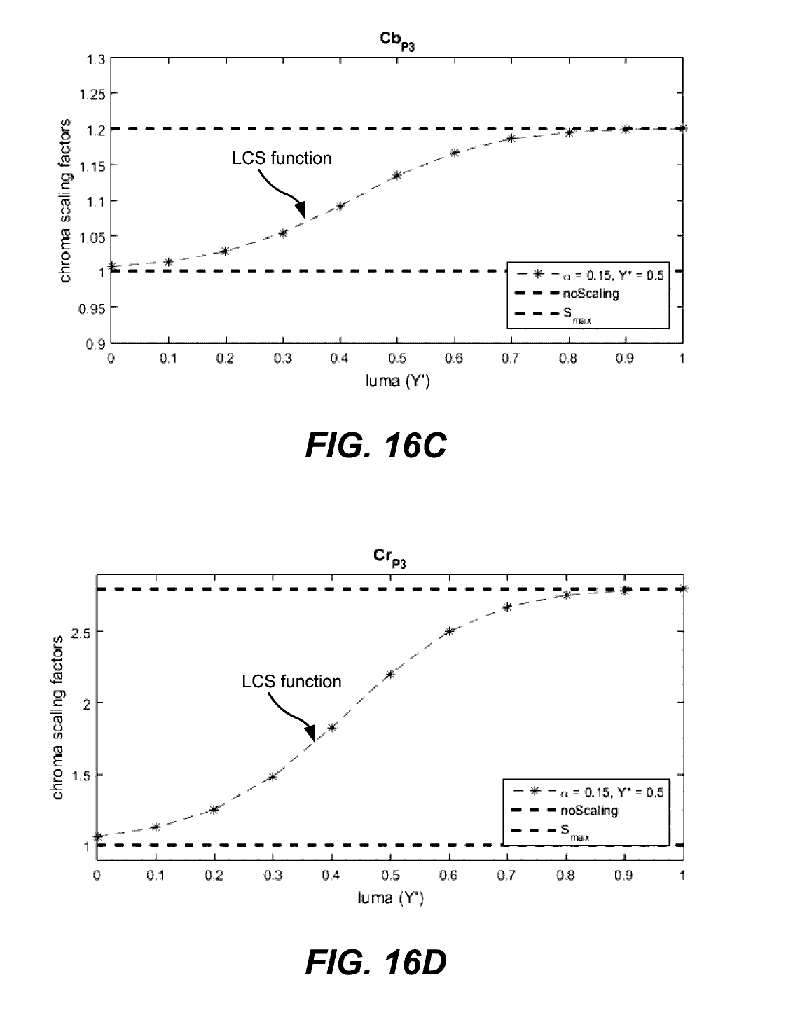

With α=0.15, Y*=0.5, and the given Sₘₐₓ, the resulting LCS functions may be monotonically increasing with respect to the input luma, Y′, from about 1.0 to Sₘₐₓ, as illustrated in FIGS. 16A-16D. These figures show LCS functions for Cb and Cr in different gamuts. For example, FIG. 16A shows Cb in BT.709, FIG. 16B shows Cr in BT.709, FIG. 16C shows Cb in DCI-P3 (D65 white), and FIG. 16D shows Cr in DCI-P3 (D65 white). Also, FIGS. 16A-16D show piece-wise linear approximations of the LCS function that use 10 linear functions, one for each equally-space range of luma component values (e.g., luma between 0 and 0.1, between 0.1 and 0.2, between 0.2 and 0.3, . . . ).

In another aspect, a piecewise polynomial weight for the chroma components that is dependent or based on the luma component is described below. In this scenario, the scaling factor may be a dividing factor on the encoder side, and it may depend on the value of the corresponding luma component for the pixel location or position (x, y) as shown in connection with Equation (11).

$${Cb}^{′} ( x , y ) = \frac{Cb ( x , y )}{{S}_{Cb} ( {Y}^{′} ( x , y ) )} , \\ {Cr}^{′} ( x , y ) = \frac{Cr ( x , y )}{{S}_{Cr} ( {Y}^{′} ( x , y ) )} \qquad ( 11 )$$

The scale may be set to 1 for most of the luma range, such that the Cb′ and Cr′ components shown in Equation (11) are the standard chroma components. The goal is then to mitigate the chroma on the darker side (e.g., scale greater than 1 for small Y′) and to enhance the chroma on the lighter side (e.g., scale smaller than 1 for large Y′). A piece-wise polynomial may be obtained or determined such that the polynomial meets these criteria. The polynomial may also meet additional requirements such as one or more of: function being a continuous function, the function having a continuous derivative, and a scaling factor for the dark and bright areas being different from 1.

A third order polynomial may be parametrized to meet these criteria. For example, a third order polynomial may be represented as follows: p(x)=a×x³+b×x²+c×x+d, where parameters a, b, c, and d may be found by applying certain conditions. For example, in the for the darker pixels:
p(0)=2 (mitigation of factor of 2 at the darkest value),
dp(0)/dx=0 (flat function at 0),
p(t)=0 (continuous function at a threshold level, t), and
dp(t)/dx=0 (continuous derivative at a threshold level, t).

The polynomial p(x) may be the function used for scaling Cb and Cr for the darker pixels. That is, the polynomial p(x) may be used for the functions S_{Cb} (Y′(x, y)) and S_{Cr}(Y′(x, y)) with respect to Cb and Cr, respectively, for the darker pixels (e.g., small Y′). Introducing the constraints described above for the mitigation of chroma below a threshold, t, the polynomial coefficients may be as follows: a=2/(t³), b=−3/(t²), c=0, and d=2. A similar approach may be carried out for the brighter pixels (e.g., larger Y′) to enhance the chroma, while ensuring a continuous, smooth function.

Polynomials of orders other than third order polynomials may also be considered, as well as the application of other or additional conditions. In this case, additional information to be provided may include: threshold below and/or above which the mitigation/enhancement starts, order of the polynomial used in each part of the luminance/luma range, and coefficients of the polynomials.

In one example, for a constant luminance (CL) configuration, parameters a_1 and b_1 may be the coefficients of the polynomial used for the low end (e.g., darker pixels) of the luminance depending on a threshold for Y, t. Parameters a_h, b_h, c_h, and d_h may be the fixed coefficients of the polynomial used for the high end (e.g., brighter pixels) of the luminance assuming a threshold for Y of 0.75.

The various parameters described above in connection with LCS operations for HDR and WCG content may be signaled from an encoding device (e.g., the encoding device 104) to a decoding device (e.g., the decoding device 112) such that the decoding device can perform the inverse LCS operations when decoding the video data. There may be different ways in which the appropriate LCS operations information may be conveyed, signaled, or indicated from one device to another. One approach may be to use an LUT-based implementation. Another approach may be to use a scales and offsets-based implementation. Each of these implementations may use particular syntax as part of, for example, an SEI message that is configured for providing LCS operations information. Such a message may be referred to as an LCS SEI message. It is to be understood, however, that other messages, including other SEI messages such as the CSI SEI message, may be configured to include syntax that also provides LCS operations information.

For an LUT-based implementation, the syntax of the LCS SEI message may be configured as shown below in TABLE 3.

TABLE 3
Syntax of the LUT-based LCS SEI Message.

De-
scrip-
tor

LCS_info( payloadSize ) {

| | |
|---|---|
| LCS_id | ue(v) |
| LCS_cancel_flag | u(1) |
| if( !LCS_cancel_flag ) { | |

| | |
|---|---|
| LCS_persistence_flag | u(1) |
| LCS_num_comps_minus1 | ue(v) |
| LCS_input_bit_depth_minus8 | ue(v) |
| LCS_output_bit_depth_minus8 | ue(v) |
| for( c = 0; c <= LCS_num_comps_minus1; c++ ) { | |

| | |
|---|---|
| LCS_num_points_minus1[ c ] | ue(v) |

| | |
|---|---|
| LCS_dependent_component_id[ c ] | ue(v) |

if( LCS_dependent_component_id[ c ] )

LCS_use_mapped_dependent_component_flag[ c ]

for( i = 0; i <= LCS_num_joints_minus1[ c ];

i++ ) {

| | |
|---|---|
| LCS_input_point[ c ][ i ] | u(v) |
| LCS_output_point[ c ][ i ] | u(v) |

}

}

}

}

With respect to semantics, the LCS SEI message provides information to perform LCS operations on decoded pictures. The color space and the components on which the scaling operations are to be performed may be determined by the value of the syntax elements signaled in the LCS SEI message.

The LCS_id syntax element shown in TABLE 3 may include an identifying number that may be used to identify the purpose of the LCS SEI message. The value of LCS_id may be in the range of 0 to 2³²−2, inclusive. The value of LCS_id may be used to specify the color space for which the LCS SEI message is to be used, or whether the LCS SEI message is applied in the linear or the non-linear domain.

Values of LCS_id from 0 to 255, inclusive, and from 512 to 2³¹−1, inclusive, may be used as determined by the application. Values of LCS_id from 256 to 511, inclusive, and from 2³¹ to 2³²−2, inclusive, may be reserved for future use. Decoders may ignore SEI messages containing a value of LCS_id in the range of 256 to 511, inclusive, or in the range of 2³¹ to 2³²−2, inclusive, and bitstreams may not contain such values.

In another aspect, LCS_id may be used to support LCS operations that are suitable for different display scenarios. For example, different values of LCS_id may correspond to different display bit depths or different color spaces in which the luma-driven chroma scaling is applied. LCS_id may also be used to identify whether the luma-driven chroma scaling is performed for compatibility to certain types of displays or decoder, e.g. HDR, SDR.

The LCS_cancel_flag syntax element shown in TABLE 3 may be set to 1 to indicate that the LCS SEI message cancels the persistence of any previous component information SEI messages in output order that applies to the current layer. LCS_cancel_flag may be set to 0 to indicate that LCS information follows.

The LCS_persistence_flag syntax element shown in TABLE 3 may specify the persistence of the LCS SEI message for the current layer. LCS_persistence_flag may be set to 0 to specify that the LCS information applies to the current decoded picture only. For a current picture, picA, LCS_persistence_flag may be set to 1 to specify that the LCS information persists for the current layer in output order until any of the following conditions are true:
a new CLVS of the current layer begins,
the bitstream ends, or
a picture, picB, in the current layer in an access unit containing an LCS SEI message with the same value of LCS_id and applicable to the current layer is output for which PicOrderCnt(picB) is greater than PicOrderCnt(picA), and where PicOrderCnt(picB) and PicOrderCnt(picA) are the PicOrderCntVal values of picB and picA, respectively, immediately after the invocation of the decoding process for picture order count for picB.

CLVS may refer to coded layer-wise video sequence (CLVS) and is a term defined in HEVC. CLVS may represent a sequence of pictures and the associated non-video coding layer (non-VCL) NAL units of the base layer of a coded video sequence (CVS). A non-VCL NAL unit (when present) for a VCL NAL unit where the VCL NAL unit is the associated VCL NAL unit of the non-VCL NAL unit. A VCL NAL unit is a collective term for coded slice segment NAL units and the subset of NAL units that have reserved values of nal_unit_type that are classified as VCL NAL units in this disclosure.

The LCS_num_comps_minus1 plus 1 syntax element shown in TABLE 3 may specify the number of components for which the LCS function is specified. LCS_num_comps_minus1 may be in the range of 0 to 2, inclusive.

When LCS_num_comps_minus1 is less than 2 and the LCS parameters of the c-th component are not signaled, the LCS parameters of the c-th component may be considered to be the same as the LCS parameters of the (c−1)-th component. Alternatively, when LCS_num_comps_minus1 is less than 2, and the LCS parameters of the c-th component are not signaled, the LCS parameters of the c-th component may be considered to be equal to default values such that effectively there is no scaling of that component.

Alternatively, the inference of the LCS parameters may be specified based on the color space on which the SEI message is applied. For example, when the color space is YCbCr, and LCS_num_comps_minus1 is equal to 1, and the LCS parameters may apply to both Cb and Cr components. When the color space is YCbCr, and LCS_num_comps_minus1 is equal to 2, the first and second LCS parameters may apply to Cb and Cr components. In one alternative, the different inference may be specified based on the value of LCS_id or on the basis of an explicit syntax element.

In an aspect, a constraint may also be added in connection with LCS_num_comps_minus1. For example, for bitstream conformance, the value of LCS_num_comps_minus1 may be the same for all the LCS SEI messages with a given value of LCS_id within a CLVS.

The LCS_input_bit_depth_minus8 plus 8 syntax element shown in TABLE 3 may specify a number of bits used to signal the syntax element LCS_input_point[c] [i]. The value of LCS_input_bit_depth_minus8 may be in the range of 0 to 8, inclusive.

When an LCS SEI message is applied to an input that is in a normalized floating point representation in the range 0.0 to 1.0, the LCS SEI message may refer to a hypothetical result of a quantization operation performed to convert input video to a video representation with bit depth equal to color_remap_input_bit_depth_minus8 plus 8.

When an LCS SEI message is applied to an input that has a bit depth different from LCS_input_bit_depth_minus8 plus 8, the LCS SEI message may refer to a hypothetical result of a transcoding operation performed to convert input video to a video representation with bit depth equal to color_remap_input_bit_depth_minus8 plus 8.

The LCS_output_bit_depth_minus8 plus 8 syntax element shown in TABLE 3 may specify a number of bits used to signal the syntax element LCS_output_point[c] [i]. The value of LCS_output_bit_depth_minus8 may be in the range of 0 to 8, inclusive.

When an LCS SEI message is applied to an input that is in floating point representation, the LCS SEI message may refer to a hypothetical result of an inverse quantization operation performed to convert video with a bit depth equal to color_remap_output_bit_depth_minus8 plus 8 that is obtained after processing of the LCS SEI message to a floating point representation in the range 0.0 to 1.0.

Alternatively, the number of bits used to signal LCS_input_point[c] [i] and LCS_output_point[c][i] may be signaled using instead LCS_input_bit_depth_and LCS_output bit depth, respectively, that is, without subtracting 8.

The LCS_num_points_minus1[c] plus 1 syntax element shown in TABLE 3 may specify a number of pivot points (e.g., reference values) used to define an LCS function. LCS_num_points_minus1 [c] may be in the range of 0 to (1<<Min(LCS_input_bit_depth_minus8 plus 8, LCS_output_bit_depth_minus8 plus 8))−1, inclusive.

The LCS_dependent_component_id[c] syntax element shown in TABLE 3 may specify the application of LUTs of the c-th component to the various components of the video. When LCS_dependent_component_id[c] is equal to 0, the syntax elements LCS_input_point[c][i] and LCS_output_point[c][i] may be used to identify mapping of input and output values of the c-th component.

When LCS_dependent_component_id[c] is greater than 0, LCS_dependent_component_id[c] minus 1 may specify the index of the component such that the syntax elements LCS_input_point[c][i] and LCS_output_point[c] [i] specify the mapping of a scaling parameter to be applied to the c-th component of a sample as a function of the value of the (LCS_dependent_component_id[c] minus 1)-th component of the sample.

The LCS_use_mapped_dependent_component_flag[c] syntax element shown in TABLE 3 may be set to 0 to specify that the scaling function to be applied on the c-th component as a function of the value of the (LCS_dependent_component_id[c] minus 1)-th component sample is applied based on the values of the (LCS_dependent_component_id[c] minus 1)-th component before the application of mapping, if any, defined in the LCS SEI message for the (LCS_dependent_component_id[c] minus 1)-th component.

LCS_use_mapped_dependent_component_flag[c] may be set to 1 to specify that the scaling function to be applied on the c-th component as a function of the value of the (LCS_dependent_component_id[c] minus 1)-th component sample is applied based on the values of the (LCS_dependent_component_id[c] minus 1)-th component after the application of mapping, if any, defined in the LCS SEI message for the (LCS_dependent_component_id[c] minus 1)-th component.

When not signaled or otherwise provided as part of a message or indication, the value of LCS_use_mapped_dependent_component_flag[c] is considered to be set to 0.

The LCS_input_point[c][i] syntax element shown in TABLE 3 may specify the i-th pivot point of the c-th component of the input picture. The value of LCS_input_point[c] [i] may be in the range of 0 to (1<<LCS_input_bit_depth_minus8[c] plus 8)−1, inclusive.

The value of LCS_input_point[c][i] may be greater than or equal to the value of LCS_input_point[c][i−1], for i in the range of 1 to LCS_points_minus1[c], inclusive.

The LCS_output_point[c][i] syntax element shown in TABLE 3 may specify the i-th pivot point of the c-th component of the output picture. The value of LCS_output_point[c] [i] may be in the range of 1 to (1<<LCS_output_bit_depth_minus8[c] plus 8)−1, inclusive.

The value of LCS_output_point[c][i] may be greater than or equal to the value of LCS_output_point[c] [i−1] for i in the range of 1 to LCS_points_minus1[c], inclusive.

The process of mapping an input signal representation, x, and an output signal representation, y, where the sample values for both input and output are in the range of 0 to (1<<LCS_input_bit_depth_minus8[c] plus 8)−1, inclusive, and 0 to (1<<LCS_output_bit_depth_minus8[c] plus 8)−1, inclusive, respectively, is specified as follows:

if(x<=LCS_input_point[c][0])

y=LCS_output_point[c][0]

else if(x>LCS_input_point[c][LCS_input_point_minus1[c]])

y=LCS_output_point[c][LCS_output_point_minus1[c]]

else

for(i=1; i<=LCS_output_point_minus1[c];++)

if(LCS_input_point[i−1]<x&& x<=LCS_input_point[i])

y=((LCS_output_point[c][i]−LCS_output_point[c][i−1])÷(LCS_input_point[c][i]−LCS_input_point[c][i−1])*(x−LCS_input_point[c][i−1])+(LCS_output_point[c][i−1])

In one alternative, input and output pivot points LCS_input_point[c][i] and LCS_output_point[c][1] may be coded as difference of adjacent values. For example, syntax elements delta LCS_input_point[ ][ ] and delta LCS_output_point[ ] [ ] may represent the difference of adjacent values, and these syntax elements may be coded using exponential Golomb codes. In another alternative, the process of mapping an input and output representation value may be specified by other interpolation methods including, but not limited to, splines and cubic interpolation.

For an scales and offsets-based implementation, the syntax of the LCS SEI message may be configured as shown below in TABLE 4. With respect to semantics, the LCS SEI message provides information to perform LCS operations on decoded pictures. The color space and the components on which the scaling operations are to be performed may be determined by the value of the syntax elements signaled in the LCS SEI message.

TABLE 4
Syntax of the scales and offsets-based LCS SEI Message.

De-
scrip-
tor

LCS_info( payloadSize ) {

| | |
|---|---|
| LCS_id | ue(v) |
| LCS_cancel_flag | u(1) |
| if( !LCS_cancel_flag ) { | |

| | |
|---|---|
| LCS_persistence_flag | u(1) |
| LCS_scale_bit_depth | u(4) |
| LCS_offset_bit_depth | u(4) |
| LCS_scale_frac_bit_depth | u(4) |
| LCS_offset_frac_bit_depth | u(4) |
| LCS_num_comps_minus1 | ue(v) |
| for( c = 0; c <= LCS_num_comps_minus1; c++ ) { | |

| | |
|---|---|
| LCS_num_ranges[ c ] | ue(v) |
| LCS_dependent_component_id[ c ] | ue(v) |
| if( LCS_dependent_component_id[ c ] ) | |

| | |
|---|---|
| LCS_use_mapped_dependent_component_flag[ c ] | u(1) |

| | |
|---|---|
| LCS_equal_ranges_flag[ c ] | u(1) |
| LCS_global_offset_val[ c ] | u(v) |
| for( i = 0; i <= LCS_num_ranges[ c ]; i++ ) | |

| | |
|---|---|
| LCS_scale_val[ c ][ i ] | u(v) |

| | |
|---|---|
| if( !LCS_equal_ranges[ c ] ) | u(v) |

for( i = 0; i <= LCS_num_ranges[ c ];

i++ )

| | |
|---|---|
| LCS_offset_val[ c ][ i ] | u(v) |

}

}

The LCS_id syntax element shown in TABLE 4 may contain an identifying number that may be used to identify the purpose of the LCS SEI message. The value of LCS_id may be in the range of 0 to 2³²−2, inclusive. The value of LCS_id may be used to specify the color space for which the LCS SEI message is to be used, or whether the LCS SEI message is applied in the linear or the non-linear domain.

In an aspect, LCS_id may specify the configuration of the HDR reconstruction process. For example, a particular value of LCS_id may be associated with signaling of scaling parameters for three components. The scaling parameters of the first component may be applied to samples of R′, G′, B′ color space, while parameters of the following two components may be applied for scaling Cr and Cb. For another LCS_id value, the HDR reconstruction process may use scaling parameters for three components, and the scaling may be applied to samples of luma, Cr, and Cb color components. For another LCS_id value, the HDR reconstruction process may utilize signaling for four components, parameters for three of the components may be applied to luma, Cr and Cb scaling, and the fourth component may include parameters for color correction.

In an aspect, a certain range of LCS_id values may be associated with HDR reconstruction conducted in SDR-backward compatible configuration, whereas a different range of LCS_id values may be associated with HDR reconstruction conducted in non-backward compatible configuration.

The values of LCS_id that range from 0 to 255, inclusive, and from 512 to 2³¹−1, inclusive, may be used as determined by the application. Values of LCS_id from 256 to 511, inclusive, and from 2³¹ to 2³²−2, inclusive, may be reserved for future use. Decoders may ignore SEI messages containing a value of LCS_id in the range of 256 to 511, inclusive, or in the range of 2³¹ to 2³²−2, inclusive, and bitstreams may not contain such values.

LCS_id may be used to support LCS processes that are suitable for different display scenarios. For example, different values of LCS_id may correspond to different display bit depths or different color spaces in which the scaling is applied. Alternatively, LCS_id may also be used to identify whether the scaling is performed for compatibility to certain types of displays or decoder, e.g. HDR, SDR.

The LCS_cancel_flag syntax element shown in TABLE 4 may be set to 1 to indicate that the LCS SEI message cancels the persistence of any previous component information SEI messages in output order that applies to the current layer. LCS_cancel_flag may be set to 0 to indicate that LCS information follows.

The LCS_persistence_flag syntax element shown in TABLE 4 may specify the persistence of the LCS SEI message for the current layer. LCS_persistence_flag may be set to 0 to specify that the LCS information applies to the current decoded picture only. For a current picture, picA, LCS_persistence_flag may be set to 1 to specify that the LCS information persists for the current layer in output order until any of the following conditions are true:
a new CLVS of the current layer begins,
the bitstream ends, or
a picture, picB, in the current layer in an access unit containing an LCS SEI message with the same value of LCS_id and applicable to the current layer is output for which PicOrderCnt(picB) is greater than PicOrderCnt(picA), and where PicOrderCnt(picB) and PicOrderCnt(picA) are the PicOrderCntVal values of picB and picA, respectively, immediately after the invocation of the decoding process for picture order count for picB.

The LCS_scale_bit_depth syntax element shown in TABLE 4 may specify the number of bits used to signal the syntax element LCS_scale_val[c][i]. The value of LCS_scale_bit_depth may be in the range of 0 to 15, inclusive.

The LCS_offset bit depth syntax element shown in TABLE 4 may specify the number of bits used to signal the syntax elements LCS_global_offset_val[c] and LCS_offset_val[c][i]. The value of LCS_offset_bit_depth may be in the range of 0 to 15, inclusive.

The LCS_scale_frac_bit_depth syntax element shown in TABLE 4 may specify the number of leas significant bits (LSBs) used to indicate the fractional part of the scale parameter of the i-th partition of the c-th component. The value of LCS_scale_frac_bit_depth may be in the range of 0 to 15, inclusive. The value of LCS_scale_frac_bit_depth may be less than or equal to the value of LCS_scale_bit_depth.

The LCS_offset_frac_bit_depth syntax element shown in TABLE 4 may specify the number of LSBs used to indicate the fractional part of the offset parameter of the i-th partition of the c-th component and global offset of the c-th component. The value of LCS_off_set_frac_bit_depth may be in the range of 0 to 15, inclusive. The value of LCS_offset_frac_bit_depth may be less than or equal to the value of LCS_offset_bit_depth.

The LCS_num_comps_minus1 plus 1 syntax element shown in TABLE 4 may specify the number of components for which the LCS function is specified. LCS_num_comps_minus1 may be in the range of 0 to 2, inclusive.

The LCS_num_ranges[c] syntax element shown in TABLE 4 may specify the number of ranges into which the output sample range is partitioned. The value of LCS_num_ranges[c] may be in the range of 0 to 63, inclusive.

The LCS_dependent_component_id[c] syntax element shown in TABLE 4 may specify the application of scales and offsets of the c-th component to the various components of the video data. When LCS_dependent_component_id[c] is equal to 0, the syntax elements LCS_global_offset_val[c], LCS_scale_val[c][i] and LCS_offset_val[c][i] may be used to identify mapping of input and output values of the c-th component. When LCS_dependent_component_id[c] is greater than 0, LCS_dependent_component_id[c]−1 may specify the index of the component such that the syntax elements LCS_global_offset_val[c], LCS_scale_val[c][i] and LCS_offset_val[c][i] specify the mapping of a scale parameter to be applied to the c-th component of a sample as a function of the value of the (LCS_dependent_component_id[c]−1)-th component of the sample.

The LCS_use_mapped_dependent_component_flag[c] syntax element shown in TABLE 4, when equal to 0, may specify that the function of scales to be applied on the c-th component as a function of the value of the (LCS_dependent_component_id[c]−1)-th component sample is applied based on the values of the (LCS_dependent_component_id[c]−1)-th component before the application of mapping, if any, defined in the SEI message for the (LCS_dependent_component_id[c]−1)-th component. When LCS_use_mapped_dependent_component_flag[c] equals to 1 it may specify that the function of scales to be applied on the c-th component as a function of the value of the (LCS_dependent_component_id[c]−1)-th component sample is applied based on the values of the (LCS_dependent_component_id[c]−1)-th component after the application of mapping, if any, defined in the SEI message for the (LCS_dependent_component_id[c]−1)-th component. When not signaled, the value of LCS_use_mapped_dependent_component_flag[c] is considered or inferred to be equal to 0.

The LCS_equal_ranges_flag[c] syntax element shown in TABLE 4, when equal to 1, may indicate that that output sample range is partitioned into LCS_num_ranges[c] nearly equal partitions, and the partition widths are not explicitly signaled. When LCS_equal_ranges_flag[c] equals to 0 it may indicate that that output sample range may be partitioned into LCS_num_ranges[c] partitions not all of which are of the same size, and the partitions widths are explicitly signaled.

The LCS_global_offset_val[c] syntax element shown in TABLE 4 may be used to derive the offset value that is used to map the smallest value of the valid input data range for the c-th component. The length of LCS_global_offset_val[c] may be LCS_offset_bit_depth bits.

The LCS_scale_val[c][i] syntax element shown in TABLE 4 may be used to derive the offset value that is used to derive the width of the of the i-th partition of the c-th component. The length of LCS_global_offset_val[c] may be LCS_offset_bit_depth bits.

The LCS_offset_val[c][i] syntax element shown in TABLE 4 may be used to derive the offset value that is used to derive the width of the of the i-th partition of the c-th component. The length of LCS_global_offset_val[c] may be LCS_offset_bit_depth bits.

In connection with the information provided by the LCS SEI message described by the syntax elements in TABLE 4, a variable CompScaleScaleVal[c][i] may be derived or obtained as follows:

CompScaleScaleVal[c][i]=(LCS_scale_val[c][i]>>LCS_scale_frac_bit_depth)+(LCS_scale_val[c][i]&((1<<LCS_scale_frac_bit_depth)−1))÷(1<<LCS_scale_frac_bit_depth)

When LCS_offset_val[c][i] is signaled, the value of CompScaleOffsetVal[c][i] may be derived as follows:

CompScaleOffsetVal[c][i]=(LCS_offset_val[c][i]>>LCS_offset_frac_bit_depth)+(LCS_offset_val[c][i]&((1<<LCS_offset_frac_bit_depth)−1))+(1<<LCS_offset_frac_bit_depth)

Alternatively, the CompScaleScaleVal[c][i] and CompScaleOffsetVal[c][i] variables may be derived as follows:

CompScaleScale Val[c][i]=LCS_scale_val[c][i]÷(1<<LCS_scale_frac_bit_depth)

CompScaleOffsetVal[c][i]=LCS_offset_val[c][i]÷(1<<LCS_offset_frac_bit_depth)

When LCS_equal_ranges_flag[c] is set to 1 and LCS_offset_val[c][i] is not signaled, then the value of CompScaleOffsetVal[c][i] may be derived as follows:

CompScaleOffsetVal[c][i]=1÷LCS_num_ranges[c]

The CompScaleOutputRanges[c][i] and CompScaleOutputRanges[c][i] variables for i in the range of 0 to LCS_num_ranges[c] may be derived as follows:

for(i=0; i<=LCS_num_ranges[c]; i++)

if(i==0)

CompScaleOutputRanges[c][i]=LCS_global_offset_val[c]+(1<<LCS_offset_frac_bit_depth)

CompScalelnputRanges[c][i]=0

else

CompScalelnputRanges[c][i]=CompScaleOffsetlnputRanges[c][i−1]+(CompScaleOffsetVal[c][i−1]*CompScaleScale Val[c][i−1])

CompScaleOutputRanges[c][i]=CompScaleOutputRanges[c][i−1]+CompScaleOffsetVal[c][i−1]

In one alternative, the values of CompScaleOutputRanges[ ][ ] and CompScaleOutputRanges[ ][ ] may be derived as follows:

for(i=0; i<=LCS_num_ranges[c]; i++)

if(i==0)

CompScalelnputRanges[c][i]=LCS_global_offset_val[c]+(1<<LCS_offset_frac_bit_depth)

CompScaleOutputRanges[c][i]=0

else

CompScalelnputRanges[c][i]=CompScaleOffsetlnputRanges[c][i−1]+(CompScaleOffsetVal[c][i−1]*CompScaleScale Val[c][i−1])

CompScaleOutputRanges[c][i]=CompScaleOutputRanges[c][i−1]+CompScaleOffsetVal[c][i−1]

The process of mapping an input signal representation, x, and an output signal representation, y, where the sample values for the input representation and for the output representation are normalized in the range of 0 to 1, may be specified as follows:

if(x<=CompScalelnputRanges[c][0])

y=CompScaleOutputRanges[c][0];

else if(x>CompScalelnputRanges[c][LCS_num_ranges[c]])

y=CompScaleOutputRanges[c][LCS_num_ranges[c]];

else

for(i=1; i<=LCS_num_ranges[c]; i++)

if(CompScalelnputRanges[i−1]<x&& x<=CompScalelnputRanges[i])

y=(x−CompScalelnputRanges[i−1])÷LCS_val[c][i]+CompScaleOutputRanges[c][i−1]

In one alternative, the value of CompScaleOutputRanges[c][0] may be set based on a permitted sample value range.

Alternatively, the process of mapping an input value, valIn, to an output value, valOut, may be defined as follows:

m_pAtfRangeIn[ 0 ] = 0;
m_pAtfRangeOut[ 0 ] = −m_offset2 *m_pAtfScale2[ c ][ 0 ];
for (int j = 1; j < m_atfNumberRanges + 1; j++)
{

m_pAtfRangeIn[ j ] = m_pAtfRangeIn[j − 1] +
m_pAtfDelta[j − 1];
m_pAtfRangeOut[ j ] = m_pAtfRangeOut[j − 1] +
m_pAtfScale2[ c ][ j −

1 ] * m_pAtfDelta[ j − 1 ];

}
for (int j = 0; j < numRanges && skip = = 0; j++)
{

if (valIn <= pAtfRangeInf[ j + 1 ])
{

valOut =

(valIn − pOffset[component][ j ]) *
pScale[ component ][ j ];

skip = 1;

}

}

In one alternative, m_offset2 may be equal to LCS_global_offset_val[c][i](1<<LCS_offset_frac_bit_depth), m_pAtfScale[c][i] may be equal to CompScaleScaleVal[c][i] and m_pAtDelta[i] may be equal to CompScaleOffsetVal[c][i] for the c-th component, and pScale and pOffset may be scale and offset parameters derived from m_AtScale and m_pAtfDelta. An inverse operation would be defined accordingly.

Aspects of the various luma-driven chroma scaling (LCS) operations and the various LCS-related parameter signaling techniques described above (e.g., LUT-based LCS SEI messages and scales- and offsets-based LCS SEI messages) may be implemented in, or be performed by, a processing system such as device 1700 shown in FIG. 17. The device 1700 may correspond to, for example, one of the wireless communication devices 115-a and 115-b shown in FIG. 1B. The device 1700 may be used as a source device, a destination device, or both.

The hardware components and subcomponents of the device 1700 may be configured to implement or perform one or more methods (e.g., method 1800 in FIG. 18) described herein in accordance with various aspects of the present disclosure. In particular, the hardware components and subcomponents of the device 1700 may perform techniques for coding of video signals with HDR and WCG representations to address some of the issues arising from handling HDR and WCG video data. Application of these techniques by the hardware components and subcomponents of the device 1700 may improve the compression efficiency of hybrid based video coding systems used for coding HDR and WCG video data.

An example of the device 1700 may include a variety of components such as a memory 1710, one or more processors 1720, and a transceiver 1730, which may be in communication with one another via one or more buses, and which may operate to enable one or more of the LCS-related functions, operations, and/or signaling techniques described herein, including one or more methods of the present disclosure.

The transceiver 1730 may include a receiver 1740 configured to receive information representative of video data (e.g., receive encoded video data from a source device). Additionally or alternatively, the transceiver 1730 may include a transmitter 1750 configured to transmit information representative of video data (e.g., transmit encoded video data to a destination device). The receiver 1740 may be a radio frequency (RF) device and may be configured to demodulate signals carrying the information representative of the video data in accordance with a cellular or some other wireless communication standard. Similarly, the transmitter 1750 may be an RF device and may be configured to modulate signals carrying the information representative of the video data in accordance with a cellular or some other wireless communication standard.

The various LCS-related functions, operations, and/or signaling techniques described herein may be included in, or be performed by, the one or more processors 1720 and, in an aspect, may be executed by a single processor, while in other aspects, different ones of the functions, operations, and/or signaling techniques may be executed by a combination of two or more different processors. For example, in an aspect, the one or more processors 1720 may include any one or any combination of an image/video processor, a modem processor, a baseband processor, a digital signal processor.

The one or more processors 1720 may be configured to perform or implement the encoding device 104, including the pre-processing 1304 having the (forward) LCS 1310. In an aspect, the one or more processors 1720 may be configured to performed additional operations associated with the encoding chains in FIGS. 5 and 13. Additionally or alternatively, the one or more processors 1720 may be configured to perform or implement the decoding device 112, including the post-processing 1320 having the inverse LCS 1326. In an aspect, the one or more processors 1720 may be configured to performed additional operations associated with the decoding chains in FIGS. 5 and 13.

The one or more processors 1720 may also be configured to configure, store, update, or otherwise handle various lookup-tables (LUTs) 1760. The LUTs 1760 may correspond to the LUTs 902 and 906 shown in FIG. 9. The LUTs 1760 may also correspond to the LUTs associated with the LUT-based implementation of the LCS SEI message for signaling LCS syntax elements as described above.

The one or more processors 1720 may also be configured to include a signaling manager 1770, which may be configured to generate, process, or otherwise handle different indications of LCS-related information. The indications may signaled as part of a message such as an SEI message. An example of a message configured to provide LCS-related information or parameters may be an LCS SEI message. The LCS-related information or parameters may be signaled as described above using different syntax elements. In one example, the LCS SEI message may use syntax elements configured for an LUT-based implementation (e.g., TABLE 3). In another example, the LCS SEI message may use syntax elements configured for a scales- and offsets-based implementation (e.g., TABLE 4). The signaling manager 1770 may be configured to generate an LCS SEI message by determining the appropriate values for the syntax elements and configuring the message accordingly. Similarly, the signaling manager 1770 may be configured to receive an LCS SEI message, read the contents of the LCS SEI message, and determine the appropriate values for the syntax elements in the LCS SEI message. Moreover, the signaling manager 1770 may be configured to compute, determine, or derive different variables as described above in connection with either generating an LCS SEI message or reading the contents of an LCS SEI message.

The memory 1710 may be configured to store data used herein and/or local versions of applications being executed by at least one processor 1720. The memory 1710 may include any type of computer-readable medium usable by a computer or at least one processor 1720, such as random access memory (RAM), read only memory (ROM), tapes, magnetic discs, optical discs, volatile memory, non-volatile memory, and any combination thereof. In an aspect, for example, the memory 1710 may be a non-transitory computer-readable storage medium that stores one or more computer-executable codes that may be executed by the one or more processors 1720 to implement or perform the various LCS-related functions, operations, and/or signaling techniques described herein.

Referring to FIG. 18, a flow chart illustrating an example method 1800 for decoding video data in HDR and WCG conditions is shown. For clarity, the method 1800 may be described below with reference to one or more of the aspects described with reference to FIGS. 1A, 1B, 13, and 17. In some examples, the device 1700 may execute one or more of the components described below, which may be implemented and/or defined in the one or more processors 1720, or in one or more sets of codes or instructions stored on a computer-readable medium (e.g., the memory 1710) as software or firmware and executable by a processor 1720, or programmed directly into a hardware element such as a module of a processor 1720, to control one or more components of the device 1700 to perform the functions described below.

For example, at block 1810, the device 1700 may optionally receive an indication of a non-linear function. The non-linear function may refer to an LCS function as described above in, for example, FIG. 14 and FIGS. 16A-16D. The indication may be part of a signal or message, such as an LCS SEI message. The indication may be an LUT-based or may be scales- and offsets-based. The indication may be received via the transceiver 1730 (e.g., via the receiver 1740 in the transceiver 1730). The indication may be received from a source device through a wireless or wireline network, or through a network that includes both a wireless and a wireline portion. Moreover, the indication may be received by the signaling manager 1770 for processing.

At block 1812, the device 1700 may obtain video data including a scaled chroma component and a luma component. The scaled chroma component may have been scaled as shown in, for example, Equations (7), (8), and (11). The scaled chroma component may be Cr‘ or Cb’, for example. In one example, the video data may be obtained from information received by the one or more processors 1720 from the receiver 1740 and processed by the one or more processors 1720. The video data may be obtained by the decoding device 112 and/or by the inverse LCS 1326.

At block 1814, the device 1700 may obtain the chroma scaling factor for the scaled chroma component, the chroma scaling factor being based on application of the non-linear function to the luma component. The chroma scaling factor for the Cb chroma component may be S_{Cb} and the chroma scaling factor for the Cr chroma component may be S_{Cr} as shown in, for example, Equations (7), (8), and (11). The chroma scaling factors may be obtained in accordance with block 1814 by the one or more processors 1720, the decoding device 112, and/or the inverse LCS 1326.

At block 1816, the device 1700 may generate the chroma component from the scaled chroma component based on the chroma scaling factor. For example, the Cb chroma component may be generated from Cb′ using S_{Cb} and the Cr chroma component may be generated from Cr′ using S_{Cr} as shown in Equation (8) and/or Equation (11). The chroma components may be generated in accordance with block 1816 by the one or more processors 1720, the decoding device 112, and/or the inverse LCS 1326.

At block 1818, the device 1700 may output the chroma component. For example, after the generation of the chroma component in block 1816, the chroma component may be provided to a color conversion or color transformation operation as shown in the post-processing 1320 in FIG. 13.

At block 1820, the device 1700 may process the chroma component. For example, the one or more processors 1720 may be configured to perform additional post-processing operations (e.g., post-processing 1320) on the chroma component.

In an aspect of method 1800, generating the chroma component includes modifying or adjusting a value of the scaled chroma component based on a value of the chroma scaling factor as illustrated by Equation (8) and/or Equation (11), for example.

In another aspect of method 1800, the indication includes an LUT, or information to recreate the LUT, which is representative of the non-linear function, and where the LUT indicates uniform or non-uniform intervals that define the non-linear function. The indication may also include a number of bits used to indicate the intervals of the LUT.

In one example of receiving an indication of an LUT, the support of the scaling function, e.g. [0, 1], may be separated into uniform ranges (intervals). For each range, use scaling and offsets that represent a linear function within the specified range, that is, piece-wise linear approximation of non-linear function. Because of the uniformity of the ranges, the number of intervals may also need to be received.

As an alternative, if non-uniform ranges are used, a better approximation maybe possible by allocating narrower ranges for sharper transitions of the non-linear function. In this case, however, providing the number of intervals may not be sufficient. If N non-uniform ranges are required, (N−1) pivot points may need to be received to represent the N non-uniform ranges. For example, in the support of [0, 1], if 2 ranges are required, one point specifying where to split should be required, e.g. 0.4, then two ranges are defined: one of [0, 0.4] and another of [0.4, 1].

In another aspect of method 1800, the chroma scaling factor of a pixel location is smaller than or equal to the chroma scaling factor of a different pixel location when the luma component of the pixel location is smaller than or equal to the luma component of the different pixel location as illustrated in the LCS functions shown in FIGS. 14 and 16A-16D.

In yet another aspect of method 1800, the chroma scaling factor may be further a function of at least one or more of a color gamut, color primaries, a sign of bi-polar chroma components, or statistics of chroma components.

Additional details related to the encoding device 104 shown in FIGS. 1A, 1B, and 17 are provided below with reference to FIG. 19. The encoding device 104 may, for example, perform operations associated with LCS and may generate syntax structures (e.g., syntax elements). The encoding device 104 may perform intra-prediction and inter-prediction coding of video data (e.g., video blocks) within video slices. Intra-coding relies, at least in part, on spatial prediction to reduce or remove spatial redundancy within a given video frame or picture. Inter-coding relies, at least in part, on temporal prediction to reduce or remove temporal redundancy within adjacent or surrounding frames of a video sequence. Intra-mode (I mode) may refer to any of several spatial based compression modes. Inter-modes, such as uni-directional prediction (P mode) or bi-prediction (B mode), may refer to any of several temporal-based compression modes.

The encoding device 104 includes a partitioning unit 35, a prediction processing unit 41, a filter unit 63, a picture memory 64, a summer 50, a transform processing unit 52, a quantization unit 54, and an entropy encoding unit 56. The prediction processing unit 41 includes a motion estimation unit 42, a motion compensation unit 44, and an intra-prediction processing unit 46. For video block reconstruction, the encoding device 104 also includes an inverse quantization unit 58, an inverse transform processing unit 60, and a summer 62. The filter unit 63 is intended to represent one or more loop filters such as a deblocking filter, an adaptive loop filter (ALF), and a sample adaptive offset (SAO) filter. Although the filter unit 63 is shown in FIG. 19 as being an in loop filter, in other configurations, the filter unit 63 may be implemented as a post loop filter. A post processing device 57 may perform additional processing on encoded video data generated by the encoding device 104. The techniques of this disclosure may in some instances be implemented by the encoding device 104. For example, LCS-related functions, operations, and/or signaling techniques may be implemented by the encoding device 104. In other instances, however, one or more of the techniques of this disclosure may be implemented by the post processing device 57.

As shown in FIG. 19, the encoding device 104 receives video data, and the partitioning unit 35 partitions the data into video blocks. The partitioning may also include partitioning into slices, slice segments, tiles, or other larger units, as wells as video block partitioning, e.g., according to a quadtree structure of LCUs and CUs. The encoding device 104 generally illustrates the components that encode video blocks within a video slice to be encoded. The slice may be divided into multiple video blocks (and possibly into sets of video blocks referred to as tiles). The prediction processing unit 41 may select one of a plurality of possible coding modes, such as one of a plurality of intra-prediction coding modes or one of a plurality of inter-prediction coding modes, for the current video block based on error results (e.g., coding rate and the level of distortion, or the like). The prediction processing unit 41 may provide the resulting intra- or inter-coded block to the summer 50 to generate residual block data and to the summer 62 to reconstruct the encoded block for use as a reference picture.

The intra-prediction processing unit 46 within the prediction processing unit 41 may perform intra-prediction coding of the current video block relative to one or more neighboring blocks in the same frame or slice as the current block to be coded to provide spatial compression. The motion estimation unit 42 and the motion compensation unit 44 within the prediction processing unit 41 perform inter-predictive coding of the current video block relative to one or more predictive blocks in one or more reference pictures to provide temporal compression.

The motion estimation unit 42 may be configured to determine the inter-prediction mode for a video slice according to a predetermined pattern for a video sequence. The predetermined pattern may designate video slices in the sequence as P slices, B slices, or GPB slices. The motion estimation unit 42 and the motion compensation unit 44 may be highly integrated, but are illustrated separately for conceptual purposes. The motion estimation, performed by the motion estimation unit 42, is the process of generating motion vectors, which estimate motion for video blocks. A motion vector, for example, may indicate the displacement of a prediction unit (PU) of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, the encoding device 104 may calculate values for sub-integer pixel positions of reference pictures stored in the picture memory 64. For example, the encoding device 104 may interpolate values of one-quarter pixel positions, one-eighth pixel positions, or other fractional pixel positions of the reference picture. Therefore, the motion estimation unit 42 may perform a motion search relative to the full pixel positions and fractional pixel positions and output a motion vector with fractional pixel precision.

The motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in the picture memory 64. The motion estimation unit 42 sends the calculated motion vector to the entropy encoding unit 56 and the motion compensation unit 44.

The motion compensation, performed by the motion compensation unit 44, may involve fetching or generating the predictive block based on the motion vector determined by motion estimation, possibly performing interpolations to sub-pixel precision. Upon receiving the motion vector for the PU of the current video block, the motion compensation unit 44 may locate the predictive block to which the motion vector points in a reference picture list. The encoding device 104 forms a residual video block by subtracting pixel values of the predictive block from the pixel values of the current video block being coded, forming pixel difference values. The pixel difference values form residual data for the block, and may include both luma and chroma difference components. The summer 50 represents the component or components that perform this subtraction operation. The motion compensation unit 44 may also generate syntax elements associated with the video blocks and the video slice for use by the decoding device 112 in decoding the video blocks of the video slice.

The intra-prediction processing unit 46 may intra-predict a current block, as an alternative to the inter-prediction performed by the motion estimation unit 42 and the motion compensation unit 44, as described above. In particular, the intra-prediction processing unit 46 may determine an intra-prediction mode to use to encode a current block. In some examples, the intra-prediction processing unit 46 may encode a current block using various intra-prediction modes, e.g., during separate encoding passes, and the intra-prediction unit processing 46 may select an appropriate intra-prediction mode to use from the tested modes. For example, the intra-prediction processing unit 46 may calculate rate-distortion values using a rate-distortion analysis for the various tested intra-prediction modes, and may select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. The intra-prediction processing unit 46 may calculate ratios from the distortions and rates for the various encoded blocks to determine which intra-prediction mode exhibits the best rate-distortion value for the block.

In any case, after selecting an intra-prediction mode for a block, the intra-prediction processing unit 46 may provide information indicative of the selected intra-prediction mode for the block to the entropy encoding unit 56. The entropy encoding unit 56 may encode the information indicating the selected intra-prediction mode. The encoding device 104 may include in the transmitted bitstream configuration data definitions of encoding contexts for various blocks as well as indications of a most probable intra-prediction mode, an intra-prediction mode index table, and a modified intra-prediction mode index table to use for each of the contexts. The bitstream configuration data may include a plurality of intra-prediction mode index tables and a plurality of modified intra-prediction mode index tables (also referred to as codeword mapping tables).

After the prediction processing unit 41 generates the predictive block for the current video block via either inter-prediction or intra-prediction, the encoding device 104 forms a residual video block by subtracting the predictive block from the current video block. The residual video data in the residual block may be included in one or more TUs and applied to the transform processing unit 52. The transform processing unit 52 transforms the residual video data into residual transform coefficients using a transform, such as a discrete cosine transform (DCT) or a conceptually similar transform. The transform processing unit 52 may convert the residual video data from a pixel domain to a transform domain, such as a frequency domain.

The transform processing unit 52 may send the resulting transform coefficients to quantization unit 54. The quantization unit 54 quantizes the transform coefficients to further reduce bit rate. The quantization process may reduce the bit_depth associated with some or all of the coefficients. The degree of quantization may be modified by adjusting a quantization parameter. In some examples, the quantization unit 54 may then perform a scan of the matrix including the quantized transform coefficients. Alternatively, the entropy encoding unit 56 may perform the scan.

Following quantization, the entropy encoding unit 56 entropy encodes the quantized transform coefficients. For example, the entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding technique. Following the entropy encoding by the entropy encoding unit 56, the encoded bitstream may be transmitted to the decoding device 112, or archived for later transmission or retrieval by the decoding device 112. The entropy encoding unit 56 may also entropy encode the motion vectors and the other syntax elements for the current video slice being coded.

The inverse quantization unit 58 and the inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within a reference picture list. The motion compensation unit 44 may also apply one or more interpolation filters to the reconstructed residual block to calculate sub-integer pixel values for use in motion estimation. The summer 62 adds the reconstructed residual block to the motion compensated prediction block produced by motion compensation unit 44 to produce a reference block for storage in the picture memory 64. The reference block may be used by the motion estimation unit 42 and the motion compensation unit 44 as a reference block to inter-predict a block in a subsequent video frame or picture.

The encoding device 104 of FIG. 19 represents an example of a video encoder configured to perform forward luma-driven chroma scaling (LCS) operations for HDR and WCG contents and to generate associated syntax elements that may be part of an encoded video bitstream.

Additional details related to the decoding device 112 shown in FIGS. 1A, 1B, and 17 are provided below with reference to FIG. 20. The decoding device 112 includes an entropy decoding unit 80, a prediction processing unit 81, an inverse quantization unit 86, an inverse transform processing unit 88, a summer 90, a filter unit 91, and a picture memory 92. The prediction processing unit 81 includes a motion compensation unit 82 and an intra prediction processing unit 84. The decoding device 112 may, in some examples, perform a decoding pass generally reciprocal to the encoding pass described with respect to the encoding device 104 from FIG. 19.

During the decoding process, the decoding device 112 receives an encoded video bitstream that represents video blocks of an encoded video slice and associated syntax elements sent by the encoding device 104. The decoding device 112 may receive the encoded video bitstream from the encoding device 104 or may receive the encoded video bitstream from a network entity 79, such as a server, a media-aware network element (MANE), a video editor/splicer, or other such device configured to implement one or more of the techniques described above. Network entity 79 may or may not include the encoding device 104. Some of the techniques described in this disclosure may be implemented by network entity 79 prior to the network entity 79 transmitting the encoded video bitstream to the decoding device 112. In some video decoding systems, the network entity 79 and the decoding device 112 may be parts of separate devices, while in other instances, the functionality described with respect to the network entity 79 may be performed by the same device that comprises the decoding device 112.

The entropy decoding unit 80 of the decoding device 112 entropy decodes the bitstream to generate quantized coefficients, motion vectors, and other syntax elements.

The entropy decoding unit 80 forwards the motion vectors and other syntax elements to the prediction processing unit 81. The decoding device 112 may receive the syntax elements at the video slice level and/or the video block level. The entropy decoding unit 80 may process and parse both fixed-length syntax elements and variable-length syntax elements.

When the video slice is coded as an intra-coded (I) slice, the intra prediction processing unit 84 of the prediction processing unit 81 may generate prediction data for a video block of the current video slice based on a signaled intra-prediction mode and data from previously decoded blocks of the current frame or picture. When the video frame is coded as an inter-coded (i.e., B, P or GPB) slice, the motion compensation unit 82 of the prediction processing unit 81 produces predictive blocks for a video block of the current video slice based on the motion vectors and other syntax elements received from the entropy decoding unit 80. The predictive blocks may be produced from one of the reference pictures within a reference picture list. The decoding device 112 may construct the reference frame lists, List 0 and List 1, using default construction techniques based on reference pictures stored in the picture memory 92.

The motion compensation unit 82 determines prediction information for a video block of the current video slice by parsing the motion vectors and other syntax elements, and uses the prediction information to produce the predictive blocks for the current video block being decoded. For example, the motion compensation unit 82 may use one or more syntax elements in a parameter set to determine a prediction mode (e.g., intra- or inter-prediction) used to code the video blocks of the video slice, an inter-prediction slice type (e.g., B slice, P slice, or GPB slice), construction information for one or more reference picture lists for the slice, motion vectors for each inter-encoded video block of the slice, inter-prediction status for each inter-coded video block of the slice, and other information to decode the video blocks in the current video slice.

The motion compensation unit 82 may also perform interpolation based on interpolation filters. The motion compensation unit 82 may use interpolation filters as used by the encoding device 104 during encoding of the video blocks to calculate interpolated values for sub-integer pixels of reference blocks. In this case, the motion compensation unit 82 may determine the interpolation filters used by the encoding device 104 from the received syntax elements, and may use the interpolation filters to produce predictive blocks.

The inverse quantization unit 86 inverse quantizes, or de-quantizes, the quantized transform coefficients provided in the bitstream and decoded by entropy decoding unit 80. The inverse quantization process may include use of a quantization parameter calculated by the encoding device 104 for each video block in the video slice to determine a degree of quantization and, likewise, a degree of inverse quantization that should be applied. The inverse transform processing unit 88 applies an inverse transform (e.g., an inverse DCT or other suitable inverse transform), an inverse integer transform, or a conceptually similar inverse transform process, to the transform coefficients in order to produce residual blocks in the pixel domain.

After the motion compensation unit 82 generates the predictive block for the current video block based on the motion vectors and other syntax elements, the decoding device 112 forms a decoded video block by summing the residual blocks from the inverse transform processing unit 88 with the corresponding predictive blocks generated by the motion compensation unit 82. The summer 90 represents the component or components that perform this summation operation. If desired, loop filters (either in the coding loop or after the coding loop) may also be used to smooth pixel transitions, or to otherwise improve the video quality. The filter unit 91 is intended to represent one or more loop filters such as a deblocking filter, an adaptive loop filter (ALF), and a sample adaptive offset (SAO) filter. Although the filter unit 91 is shown in FIG. 20 as being an in loop filter, in other configurations, the filter unit 91 may be implemented as a post loop filter. The decoded video blocks in a given frame or picture are then stored in the picture memory 92, which stores reference pictures used for subsequent motion compensation. The picture memory 92 also stores decoded video for later presentation on a display device, such as video destination device 122 shown in FIG. 1A.

The decoding device 112 of FIG. 20 represents an example of a video decoder configured to perform inverse luma-driven chroma scaling (LCS) operations for HDR and WCG contents and to process associated syntax elements that may be part of an encoded video bitstream received by the decoding device 112.

The techniques of this disclosure may be performed by a video encoding device such as the encoding device 104 in FIG. 19, by a video decoding device such as the decoding device 112, or by a video encoder/decoder, typically referred to as a “CODEC.” Moreover, the techniques of this disclosure may also be performed by a video preprocessor.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The disclosure set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The disclosure includes specific details for the purpose of providing an understanding of the described techniques. These techniques, however, may be practiced without these specific details. In some instances, well-known structures and apparatuses are shown in block diagram form in order to avoid obscuring the concepts of the described examples.

The functions described herein may be implemented in hardware, software executed by a processor, firmware, or any combination thereof. If implemented in software executed by a processor, the functions may be stored on or transmitted over as one or more instructions or code on a (non-transitory) computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable medium as described herein may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

What is claimed is:

1. A method of video data decoding in high dynamic range and wide color gamut operations, the method comprising:
obtaining video data, the video data including a scaled chroma component and a luma component, the scaled chroma component being scaled based on a chroma scaling factor that is a non-linear function of the luma component;
obtaining the chroma scaling factor for the scaled chroma component;
generating a chroma component from the scaled chroma component based on the chroma scaling factor; and
outputting the chroma component.

2. The method of claim 1, wherein generating the chroma component includes modifying a value of the scaled chroma component based on a value of the chroma scaling factor.

3. The method of claim 1, further comprising receiving an indication of the non-linear function, wherein obtaining the chroma scaling factor includes obtaining the chroma scaling factor based on the indication.

4. The method of claim 3, wherein the indication includes:
a look-up table (LUT) representative of the non-linear function, where the LUT indicates uniform or non-uniform intervals that define the non-linear function, and
a number of bits used to indicate the intervals of the LUT.

5. The method of claim 1, wherein receiving the indication comprises receiving a supplemental enhancement information (SEI) message configured to include the indication.

6. The method of claim 1, wherein the chroma scaling factor of a pixel location is smaller than or equal to the chroma scaling factor of a different pixel location when the luma component of the pixel location is smaller than or equal to the luma component of the different pixel location.

7. The method of claim 1, wherein the chroma scaling factor is further a function of at least one or more of a color gamut, color primaries, a sign of bi-polar chroma components, or statistics of chroma components.

8. The method of claim 1, wherein the scaled chroma component is one of a scaled Cr component or a scaled Cb component, and the chroma component is a Cr component or a Cb component, respectively.

9. The method of claim 1, the method being executable on a wireless
communication device, wherein the device comprises:
a memory configured to store the video data;
a processor configured to execute instructions to process the video data stored in the memory; and
a receiver configured to receive information representative of the video data.

10. The method of claim 9, wherein the wireless communication device is a cellular telephone and the information representative of the video data is received by the receiver and modulated according to a cellular communication standard.

11. A device for video data decoding in high dynamic range and wide color gamut operations, the device comprising:
a memory configured to store video data; and
a processor configured to:
obtain the video data, the video data including a scaled chroma component and a luma component, the scaled chroma component being scaled based on a chroma scaling factor that is a non-linear function of the luma component;
obtain the chroma scaling factor for the scaled chroma component;
generate a chroma component from the scaled chroma component based on the chroma scaling factor; and
output the chroma component.

12. The device of claim 11, wherein the processor is configured to generate the chroma component by modifying a value of the scaled chroma component based on a value of the chroma scaling factor.

13. The device of claim 11, wherein:
the processor is further configured to receive an indication of the non-linear function, and
the processor is configured to obtain the chroma scaling factor based on the indication.

14. The device of claim 13, wherein the indication includes:
a look-up table (LUT) representative of the non-linear function, where the LUT indicates uniform or non-uniform intervals that define the non-linear function, and
a number of bits used to indicate the intervals of the LUT.

15. The device of claim 11, wherein the chroma scaling factor of a pixel location is smaller than the chroma scaling factor of a different pixel location when the luma component of the pixel location is smaller than the luma component of the different pixel location.

16. The device of claim 11, wherein the chroma scaling factor is further a function of at least one or more of a color gamut, color primaries, a sign of bi-polar chroma components, or statistics of chroma components.

17. The device of claim 11, wherein the scaled chroma component is one of a scaled Cr component or a scaled Cb component, and the chroma component is a Cr component or a Cb component, respectively.

18. The device of claim 11, wherein the device is a wireless communication device, further comprising:
a receiver configured to receive information representative of the video data.

19. The device of claim 18, wherein the wireless communication device is a cellular telephone and the information is received by the receiver and modulated according to a cellular communication standard.

20. A computer-readable medium storing code for video data decoding in high dynamic range and wide color gamut operations, the code being executable by a processor to perform a method comprising:
obtaining video data, the video data including a scaled chroma component and a luma component, the scaled chroma component being scaled based on a chroma scaling factor that is a non-linear function of the luma component;
obtaining the chroma scaling factor for the scaled chroma component;
generating a chroma component from the scaled chroma component based on the chroma scaling factor; and
outputting the chroma component.
